(19) United States
(12) Patent Application Publication
(10) Pub. No.: US 2025/0114732 A1
(43) Pub. Date: Apr. 10, 2025

(54) FILTRATION MEDIA FOR LIQUID FILTERS

(71) Applicant: DelStar Technologies, Inc., Alpharetta, GA (US)

(72) Inventors: Andrew G. Platt, Middletown, DE (US); Lenny Pompeo, Alpharetta, GA (US); Yasar Kiyak, Alpharetta, GA (US)

(21) Appl. No.: 18/906,031

(22) Filed: Oct. 3, 2024

Related U.S. Application Data
(60) Provisional application No. 63/588,326, filed on Oct. 6, 2023.

(51) Int. Cl. B01D 39/14

(52) U.S. Cl. CPC B01D 39/14; B01D 2239/0258; B01D 2239/0604

(57) ABSTRACT

Filter media for use in liquid filters and liquid filters are provided that include a substrate, such as a porous membrane, and nanoparticles incorporated into the substrate. The nanoparticles may comprise nanoparticles, nanofibers or mini fibers that have at least one dimension less than about 20 microns. The nanoparticles are bonded to the fibers within the substrate and are dispersed “in depth” within the substrate, which improves the performance characteristics of the material for a number of different applications. For example, the nanoparticles increase the overall surface area within the substrate, which may increase its filtration efficiency and allow for the capture of submicron contaminants without significantly compromising other factors, such as bubble point or through-put across the filter.

### CROSS-REFERENCE TO RELATED APPLICATIONS

This application claims the benefit of U.S. Provisional Application Ser. No. 63/588,326, filed Oct. 6, 2023, the complete disclosure of which is incorporated herein by reference for all purposes.

### TECHNICAL FIELD

This description generally relates to filtration media for liquid filters that comprise a fiber substrate and nanoparticles, nanofibers and/or mini fibers incorporated into the fiber substrate.

### BACKGROUND

Porous membranes are widely used for a variety of applications depending on their properties such as the material used for making said membranes, their morphology and the size of the membrane pores. These membranes can be used, for example, as filtration media, separation membranes, membrane adsorbers, membrane catalysts or membrane bioreactors.

One particular application for porous membranes is in liquid filtration. Liquid filtration is the process of removing solid particles, impurities, and contaminants that are suspended in a fluid stream. It generally involves the flow of the process liquid (in the form of slurries and suspensions) through a permeable filter medium and the blocking and retention of the captured solids.

There are two main types of liquid filtration: surface and depth. The filtration method is primarily distinguished from the structure of its filter medium. In surface filtration, the particle screening takes place on the surface of the filter medium. Interstitial spaces, called pores, are present between the fibers of the filter medium. Particles that have a larger diameter than the pore width are blocked on the upstream side of the filter medium and form the filter cake. Particles that have a smaller diameter than the pore width are allowed to pass through the filter medium. At the start of the filtration process, the filter efficiency is around 50-60%. It increases up to 100% as the filter cake builds up, as the filter cake also offers resistance to the flow of the particles.

Surface filters are economical in liquid filtration. However, this type of filtration has a lower particle holding capacity and is more prone to clogging. They also require more frequent replacements but they can be reused after cleaning.

Depth filtration is used to retain the particles throughout the depth of the filter medium. Depth filters typically use a thick, multi-layered filter medium that increases its density towards the direction of the flow. The larger particles are retained on the surface of the filter, which has the least media density, and the particle size progressively becomes finer across the depth of the filter. The high pore volume of the filter presents a tortuous and difficult flow path for the solid to pass through. The greater resistance it offers effectively blocks the solid particles from combining into the filtrate.

Depth filters are typically used when the processed liquid contains a wide range of particle sizes. Depth filters can filter particles smaller than the mean flow pore size and they have a higher particle holding capacity and can trap a large volume of solids before they become clogged. They can remove gelatinous particles from the process liquid. Lastly, they have a long service life and are less frequently replaced but they are typically single-use products.

When identifying the required flow rate, the key considerations are pore size and required liquid throughput. The pore size of the membrane is selected based on the intended performance of the final device. The pore rating dictates the functional attributes of the membrane, including flow rate and throughput. For example, the use of membranes with smaller pore sizes will generally increase the efficiency of the filter in capturing contaminants. On the other hand, these smaller pore sizes will generally result in lower flow rates and reduced throughput compared to membranes with larger pore sizes.

Accordingly, it would be desirable to provide improved filter media for use with liquid filters. It would be particularly desirable to provide filter media that has reduced pore sizes to increase the efficiency of capturing contaminants, while substantially maintaining the flow rate or throughput of the filter media.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Various embodiments provide filter media that comprise a substrate including fibers and nanoparticles dispersed throughout at least a portion of the filter media. At least some of the nanoparticles are bonded to at least some of the fibers in the substrate. In some embodiments, the substrate comprises a porous membrane that may be configured for use as a filter media and is particularly useful for liquid filters used in a variety of industries, such as pulp and paper, food and beverage, steel production, industrial process fluids, waste water, municipal, automotive, power generation, semiconductor manufacturing, mining/construction, petroleum/chemical refining, medical/pharmaceutical and general manufacturing.

In various embodiments, the nanoparticles are thermally bonded to the fibers. The fibers and nanoparticles may be heat bonded, ultrasonically bonded, calendered, air bonded or a combination thereof. The thermal bonding may be with or without pressure.

In various embodiments, the filter media includes a binder or adhesive that bonds the fibers to the nanoparticles. The adhesive may be, for example, spray-coated onto the substrate before and/or after the nanoparticles are dispersed therein. The adhesive inhibits the nanoparticles from passing right through the membrane and may increase the uniformity and penetration of the nanoparticles within the internal structure of the membrane as they bind to the adhesive. The adhesive is preferably a non-soluble adhesive that will not substantially dissolve in the liquid passing through the filter. Suitable non-soluble adhesives include, but are not limited to, polyurethane, epoxy, polyimide, starch, dextrin, latex, acrylonitrile, polyvinyl alcohol, polyvinyl acetate, polyvinyl chloride, acrylic, ethylene-vinyl acetate, polyolefins, phenol formaldehyde resins, urea formaldehyde, polysulfides, cyanoacrylate and combinations thereof.

The nanoparticles described herein generally have at least one dimension less than about 20 microns. In some embodiments, the nanoparticles have at least one dimension less than 1 micron (i.e., diameter, width, height, or the like depending on the cross-sectional shape of the fiber). In other embodiments, the nanoparticles comprise mini-fibers or nanofibers that have at least one dimension between about 1 micron to about 20 microns. For example, a mini-fiber or nanofiber having a diameter or width less than a micrometer and a length greater than 1 micrometer is a nanoparticle as used herein. In an exemplary embodiment, the mini fibers have at least one dimension of about 5 microns. The nanoparticles may have a continuous length, or the nanoparticles may have discrete length, such as 1 to 100,000 microns, preferably between about 5 to 10,000 microns, or between about 5 to about 1,000 microns, or about 100 to about 600 microns.

The nanoparticles may comprise any suitable material, such as glass, biosoluble glass, ceramic materials, acrylic, carbon, metal, such as alumina, polymers, such as polyethylene, high density polyethylene (HDPE) low density polyethylene (LDPE) nylon, polyethylene terephalate, polypropylene (PP), polybutylene (PBT), ethylene polyester (PET), polylactic acid (PLA), polyamide (PA), polyvinyl chloride (PVC), polyolefin, polyacetal, polyester, cellulous ether, polyalkylene sulfide, poly(arylene oxide), polysulfone, modified polysulfone polymers and polyvinyl alcohol, polyamide, polystyrene, polyacrylonitrile, polyvinylidene chloride, polymethyl methacrylate, polyvinylidene fluoride and any combination thereof.

In embodiments, the nanoparticles comprises mini fibers selected from a group including, but not limited to, metallic fibers, carbon fibers, polypropylene (PP), nylon fibers, polybutylene (PBT), ethylene polyester (PET), polylactic acid (PLA), polyamide (PA), glass, biosoluble glass, ceramic materials, acrylic, polyethylene, high density polyethylene (HDPE) low density polyethylene (LDPE) and combinations thereof.

In embodiments, the fiber substrate comprises a porous membrane. In an exemplary embodiment, the porous membrane has a mean flow pore size of less than about 10 microns. The nanoparticles reduce the mean flow pore size of the membrane, while substantially maintaining the liquid flow rate through the membrane.

In embodiments, the mean flow pore size of the membrane is less than 5 microns, preferably less than 4 microns, and preferably less than 3 microns, preferably less than about 1 micron.

The fibers within the substrate may be artificial or natural fibers. Suitable materials for the substrate fibers include, but are not limited to, metallic fibers, carbon fibers, polypropylene (PP), polyesters (PET), PEN polyester, PCT polyester, polybutylene (PBT), ethylene polyester (PET), polylactic acid (PLA), polyamide (PA),co-polyamides, polyethylene, high density polyethylene (HDPE), low density polyethylene (LDPE), cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluoroethylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene or any combination thereof.

In certain embodiments, the fibers within the substrate may comprise polyolefins, polyester, polyethylene (PE), polypropylene (PP), blends of PP and PE, PBT, PET, CoPET, PLA, PA, PHB, PVOH, PVA polyamide and a combination thereof. In an exemplary embodiment, the substrate comprises bicomponent fibers, such as CoPET/PET or HDPE/PET.

The fibers may be manufactured and formed into the substrate in any suitable manner including, but not limited to, meltblown, spunbond or spunlace, gradient spunbond, thermally bonded, bonded carded, air-laid, wet-laid, cellulose wet-laid, glass wet-laid, synthetic wet-laid, composite wet-laid, co-formed, needlepunched, stitched, hydraulically entangled, hydroentangled, ultrasonically bonded or the like. In all of the above examples, the fibers may be hydroentangled or hydraulically entangled. In one exemplary embodiment, the web formation is either drylaid (carded), wetlaid or bicomponent spunbond. In a particularly preferred embodiment, the substrate comprises wetlaid bicomponent fibers, such as CoPET/PET or HDPE/PET.

The fibers within the substrate may have many shapes in cross-section, including without limitation, circular, kidney bean, dog bone, trilobal, barbell, bowtie, star, Y-shaped, and others. With different denier fiber ranges within each portion. The fibers may include biocomponent fibers that include two or more different fibers bonded to each other. The fibers may comprise the same material or different materials. The fibers may comprise biocomponent fibers having a core and a sheath. The core may be concentric or eccentric relative to the longitudinal axis of the sheath.

In certain embodiments, the nanoparticles are isolated within a fluid and dispersed through a first surface of the substrate. The fluid may, for example, be a gaseous medium such as air, helium, nitrogen, oxygen, carbon dioxide and the like. The nanoparticles may be dispersed from this gaseous medium via a gas stream, aerosol, vaporizer, spray, or other suitable delivery mechanism.

In embodiments, the substrate is advanced from an upstream end to a downstream end and groups of nanofibers are fed into a fluid medium. The groups of nanofibers are converted into nanoparticles within the fluid medium and then dispersed into the substrate between the upstream and downstream ends to form the filter media.

In certain embodiments, the nanoparticles are dispersed “in-depth” within the substrate or porous membrane. As used herein, the term “in-depth” means that the nanoparticles are dispersed beyond the first surface of the membrane such that at least some of the nanoparticles are disposed between the first and second opposing surfaces in the internal structure of the membrane. In certain embodiments, the nanoparticles are dispersed throughout substantially the entire membrane from the first surface to the opposing second surface. In other embodiments, the nanoparticles are dispersed through a portion of the membrane from the first surface to a location between the first and second surfaces.

The nanoparticles may be disposed on the first and/or second opposite surfaces of the membrane such that the area density of the nanoparticles decreases from the first surface towards the second surface, or a higher area density of nanoparticles is disposed on one or both of the two surfaces as compared to the middle section of the membrane. In certain embodiments, the density of nanoparticles located at the first surface differs by less than 50% of the density of nanoparticles dispersed within the central portion or midpoint of the substrate between the two surfaces. In some embodiments, this difference is less than 25%, preferably less than 10%. In certain embodiments, the amount or number of individual nanoparticles dispersed within the central portion of the membrane is at least about 50% of the amount of individual nanoparticles dispersed at or near the first surface, preferably at least about 75% and more preferably at least about 90%.

In some embodiments, the nanoparticles may be added into the membrane from both the first and second surfaces. In these embodiments, the area density or “add-on amount” at the first and second surfaces may be substantially equal to each other, or they may be different depending on the application. In these embodiments, the area density or “add-on amount” that is present in the middle of the substrate is lower than at the outer surfaces. For example, the area density in the middle of the substrate may be about 75% of the area density at the outer surfaces, or it may be about 50%, 40% or 25%.

In another aspect, a liquid filter comprises a housing comprising an inlet for receiving a liquid and an outlet for discharging the liquid and a fiber substrate disposed within the housing between the inlet and the outlet. The fiber substrate comprises a first surface, an opposing second surface and a plurality of nanoparticles disposed within the fiber substrate at least between the first and second surfaces.

In embodiments, the liquid filter is a depth filter and/or an alluvial filter. The housing may comprise any suitable housing for a liquid filter, such as a cartridge, bag, centrifuge or the like.

In embodiments, the fiber substrate comprises a porous membrane comprising fibers and having a mean flow pore size of less than about 10 microns. In embodiments, the mean flow pore size of the membrane is less than 5 microns, preferably less than 4 microns, preferably about 3 microns, and preferably less than 1 micron.

The filter has a bubble point of less than about 20 in/h20, or less that about 15 in/h20. The bubble point is defined herein as the amount of force required to pass liquid through the substrate (i.e., the higher the number, the more difficult it is to pass the liquid therethrough).

In embodiments, the liquid filter may comprise, for example, an intake filter, a panel filter, a filter press, a rotary drum filter, a clean-in-place (CIP) filter, a bag filter or a cartridge filter. The cartridge may comprise a square-end cap cartridge, a V-bank compact filter, a flat cell filter, pleated cartridge, conical filter cartridge, spun-bonded cartridge, activated carbon filter cartridge, reverse osmosis membrane cartridge, alkaline filter cartridge, ultraviolet filter cartridge, synthetic filter media, wound cartridge or the like.

In embodiments, the liquid filter comprises a fuel filter, such as a diesel fuel filter, hydrocarbon fuel filter, gasoline fuel filter, canister fuel filter, inline fuel filter, in-tank fuel filter, cartridge fuel filter, carburetor inlet filter, pump-outlet fuel filter, spin-on fuel filter and the like.

In embodiments, the liquid filter comprises a semiconductor processing filter, such as microfiltration filter, chemical filter, CMP filter, lithography filter, process gas filter, chemical mechanical polishing filter, wastewater filter, wet etch and clean filter, PFOA filter and the like.

In embodiments, the liquid filter comprises a municipal filter, such as a wastewater filter for use in a water treatment plant. The municipal filter may include, but is not limited to, screen filters, slow sand filters, disc filters, rapid sand filters, membrane filters, bag filters, membrane filters, reverse osmosis filters and the like.

In embodiments, the liquid filter comprises a pipeline filter, such as a turbine air filter, particulate filter, clay treater filter, amine filter, two-stage coalescer-separator, strainer, natural gas pipeline filter, Y-type filter, T-type filter, basket filter, magnetic filter, backwash filter and the like.

In embodiments, the liquid filters comprises a food or beverage filter, such as a filter configured for use in manufacturing fruit juices and soft drinks, a water filter for use in sinks and pitchers, a basket centrifuges for use in producing salt, a disc centrifuges for use in separating cream from milk, a water purification membranes, a rotary vacuum drum filter for use in separating sugar juice from mud, a hydro cyclone for use in purifying starch, a disc or tubular centrifuge for use in refining vegetable seed oils, a decanter centrifuge or filter press for use in de-watering separated grains in, for example, a distillery or brewery and the like.

In embodiments, the liquid filter may be configured for use in the pharmaceutical manufacturing industry for plasma fractionation, specialty enzymes, vitamins, diagnostics, phytopharmaceuticals, red biotechnology, white biotechnology and may include filters, such as magnetic filters, bag filters, self-cleaning filters, reverse osmosis filter membranes, ultrafiltration filter membranes and nanofiltration filter membranes and the like.

In embodiments, the liquid filter may be configured for use as an industrial filter, such as one provided for chemicals, manufacturing paints, organic solvents, ink, petroleum and kerosene industrial water treatment, cosmetics, wineries and pharmaceuticals, including pleated filter cartridges, melt-blown filter cartridges, string wound filter cartridges, membrane filter cartridges, carbon filter cartridges, and other specialty filter cartridges.

In embodiments, the liquid filter comprises a hydraulic filter, such as an oil filter, spin-on filter, return line filter, duplex filter, off-line or in-line filter, tank filter and the like.

In embodiments, the liquid filter comprises a metallic filter, such as a stainless steel, copper, activated carbon, aluminum or the like.

In embodiments, the liquid filter comprises a battery separator, such as an alkaline battery separator, including, but not limited to, zinc-manganese dioxide (Zn/MnO₂), nickel-cadmium (Ni—Cd,), and nickel-hydrogen (Ni—H₂) batteries.

The recitation herein of desirable objects which are met by various embodiments of the present description is not meant to imply or suggest that any or all of these objects are present as essential features, either individually or collectively, in the most general embodiment of the present description or in any of its more specific embodiments.

### BRIEF DESCRIPTION OF THE DRAWINGS

FIG. 1 is a side view of a filter media with nanoparticles dispersed into a portion of the material;

FIG. 2 is a side view of a filter media with nanoparticles dispersed throughout the material;

FIG. 3 is a side view of a filter media with nanoparticles dispersed in a gradient through the material;

FIG. 4 illustrates a dual-layer filter media;

FIGS. 5A-5C illustrate biocomponent fibers incorporated into a porous membrane;

FIG. 6 illustrates a liquid cartridge filter;

FIG. 7 illustrates a liquid bag filter;

FIG. 8 illustrates a metallic filter comprising a perforated sheet;

FIG. 9 illustrates a synthetic filter media;

FIG. 10 illustrates a pleated filter cartridge;

FIG. 11 illustrates a spun-bond filter cartridge;

FIG. 12 illustrates a wound cartridge;

FIG. 13 illustrates a membrane filter cartridge;

FIG. 14 is partial cross-sectional view of a liquid filter housing;

FIG. 15 illustrates a multi-bag filter system;

FIG. 16 illustrates a rotary drum filter;

FIG. 17 illustrates a filter press;

FIG. 18A is a partial cross-sectional view of a fuel filter;

FIG. 18B is a partial cross-sectional view of a fuel filter for a vehicle;

FIG. 19 illustrates a filter for removing large slurry particles in semiconductor manufacturing apparatus;

FIG. 20 illustrates a water filtration device for a semiconductor manufacturing apparatus;

FIG. 21 illustrates a pipeline filter;

FIG. 22 schematically illustrates a system for manufacturing filter media;

FIG. 23 schematically illustrates a system for breaking down and/or isolating individual nanoparticles and dispersing the nanoparticles onto a substrate;

FIG. 24 illustrates an eductor of the system of FIG. 23;

FIG. 25 illustrates a reactor of the system of FIG. 23;

FIG. 26 illustrates another embodiment of a system for breaking down and/or isolating individual nanoparticles and dispersing the nanoparticles onto a substrate;

FIG. 27 illustrates a system for manufacturing a dual-layer filter media;

FIG. 28 is a schematic view of a feed system for conveying nanoparticles into one of the filter media manufacturing systems described above;

FIG. 29 is a more detailed view of the feed system of FIG. 28;

FIG. 30 is a partial cross-sectional schematic view of a bulk bin for receiving clusters of nanoparticles and introducing the nanoparticles into the feed system of FIGS. 28 and 29;

FIG. 31 is another schematic view of the bulk bin of FIG. 30;

FIG. 32 illustrates rotors within an interior of the bulk bin;

FIG. 33 is an enlarged view of a lower opening of the bulk bin, illustrating a portion of an elevator configured to convey nanoparticles away from the bulk bin and elevate them through the feed system;

FIG. 34 illustrates one portion of the elevator;

FIG. 35 illustrates another portion of the elevator;

FIG. 36 illustrates clusters of nanoparticles within the portion of the elevator shown in FIG. 35;

FIG. 37 illustrates a receiving vessel for conveying the nanoparticles from the elevator to a feed bin;

FIG. 38 is a schematic view of the feed bin;

FIG. 39 is another schematic view of the feed bin;

FIG. 40 illustrates an interior portion of the feed bin;

FIG. 41 is an expanded view of the interior of the feed bin, illustrating an auger for conveying the nanoparticles away from the feed bin;

FIG. 42 illustrates another receiving vessel from conveying the nanoparticles from the feed bin to the fiber manufacturing system;

FIG. 43 illustrates a fine-tuned flow control device for conveying the nanoparticles into a fiber manufacturing apparatus; and

FIG. 44 illustrates a vibration element for vibrating one of the receiving vessels to convey nanoparticles therethrough.

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Various embodiments provide filter media that comprise a substrate including fibers and nanoparticles dispersed throughout at least a portion of the filter media. In some embodiments, the substrate comprises a porous membrane that may be configured for use as a filter media and is particularly useful for liquid filters used in a variety of industries, such as pulp and paper, food and beverage, steel production, industrial process fluids, waste water, municipal, automotive, power generation, semiconductor manufacturing, mining/construction, petroleum/chemical refining, medical/pharmaceutical and general manufacturing. The filter media provide herein are particularly useful in depth filters and/or alluvial filters. When used in alluvial filters, a filter aid may be included in the liquid filter. Suitable filter aids include, but are not limited to, diatomaceous earth, perlite, cellulose, fly ash, carbon, silica, Solkafloc and combinations thereof.

For example, various embodiments include fuel filters, such as diesel fuel filters, hydrocarbon fuels, gasoline fuel filters, canister fuel filters, inline fuel filters, in-tank fuel filters, cartridge fuel filters, carburetor inlet filters, pump-outlet fuel filters, spin-on fuel filters and the like.

For example, various embodiments include gas turbine and compressor air intake filters, panel filters, filter presses, rotary drum filters, water plant treatment filters, biological filters, membrane bioreactor membranes, hydrocarbon filters, diesel filters, fuel filters, hydraulic fluid filters, food and beverage filters, semiconductor filters, microfiltration membranes, downstream membrane filtration, pharmaceutical and medical filters, waste water filters, industrial process and/or municipal filters, pipelines gas turbine and compressor air intake filters, panel filters, cartridge filters, bag filters, clean-in-place (CIP) filters, battery separators and the like.

For example, various embodiments include semiconductor processing filters to filter nano-sized particles and harmful contaminants during logic and chip fabrication, including microfiltration filters with hydrophobic or hydrophilic membranes, chemical filters, CMP filters, lithography filters, process gas filters and purifiers, chemical mechanical polishing filters, electrolyte plating, wastewater filters, wet etch and clean filters, PFOA filters and the like.

For example, various embodiments include filters for the food and beverage industry for removing solid and/or liquid contaminants, such as filters for manufacturing fruit juices and soft drinks, water filters in sinks and pitchers, basket centrifuges for producing salt, disc centrifuges for separating cream from milk, water purification membranes, rotary vacuum drum filters for separating sugar juice from mud, hydro cyclones for purifying starch, disc or tubular centrifuges for refining vegetable seed oils, decanter centrifuges or filter presses for de-watering separated grains in, for example, a distillery or brewery.

For example, various embodiments include filters for use in the pharmaceutical manufacturing industry for plasma fractionation, specialty enzymes, vitamins, diagnostics, phytopharmaceuticals, red biotechnology, white biotechnology and may include filters, such as magnetic filters, bag filters, self-cleaning filters, reverse osmosis filter membranes, ultrafiltration filter membranes and nanofiltration filter membranes and the like.

For example, in various embodiments, industrial filters are provided for removing solid and/or liquid contaminants from liquid process streams in refining, petrochemical, chemical, oil and gas, manufacturing paints, organic solvents, ink, petroleum and kerosene industrial water treatment, cosmetics, wineries and pharmaceuticals, including pleated filter cartridges, melt-blown filter cartridges, string wound filter cartridges, membrane filter cartridges, carbon filter cartridges, wound fiber depth style liquid filter cartridges, stainless steel filter cartridges, pleated series liquid cartridges, and other specialty filter cartridges. These filters may be rated from less than about 1 micron to about 100 microns.

For example, hydraulic filters are provided for removing particulate matter from hydraulic fluids. The hydraulic filters may be full flow or partial flow and may include, but are not limited to, oil filters, spin-on filters, return line filters, duplex filters, off-line and in-line filters and tank filters.

For example, various embodiments include municipal filters, such as filters used in water treatment plants. These filters may include, but are not limited to, screen filters, slow sand filters, disc filters, rapid sand filters, membrane filters, bag filters, membrane filters, reverse osmosis filters and the like.

For example, various embodiments include gas pipeline filters, such as turbine air filters, particulate filters, clay treater filters, amine filters, two-stage coalescer-separators, strainers, natural gas pipeline filters, Y-type filters, T-type filters, basket filters, magnetic filters, backwash filters and the like.

For example, various embodiments include power generation filters, such as hydropower generation filters, solar power generation filters, nuclear power generation filters, water filter cartridges, sintered metal filters, wedge wire filters, demister pad filters and the like.

For example, various embodiments include battery separators that serve as a mechanical barrier between the electrodes to prevent shorting while allowing for ionic transport through the electrolyte in the pores. For example, various embodiments include an alkaline battery separator, including, but not limited to, zinc-manganese dioxide (Zn/MnO₂), nickel-cadmium (Ni—Cd,), and nickel-hydrogen (Ni—H₂) batteries. The battery separators may include a substrate comprising blends of polyvinyl alcohol (PVA) fibers and cellulose or cellulose derivatives such as rayon or lyocell.

Various embodiments also provide systems, devices, and methods for producing the porous membrane, filter media and the products containing the porous membrane or filter media (e.g., liquid filters). Such systems and methods may include isolating individual nanoparticles in a gaseous medium, such as air, helium, nitrogen, oxygen, carbon dioxide, and the like (instead of a liquid) and dispersing the nanoparticles into the porous membrane via a gas stream, aerosol, vaporizer, spray or other suitable delivery mechanism.

While the following description is primarily presented with respect to filter media and liquid filters, it should be understood that devices and methods disclosed herein may be readily adapted for use in a variety of other applications. For example, the filter media disclosed herein may be useful in household cleaning products, roofing and flooring products, automobile upholstery and headliners, reusable bags, wallcoverings, filtration devices, insulation and the like. In addition, the individual nanoparticles that are isolated and generated in the processes described herein may be utilized in various coatings, composites and/or additives in, for example, polymers, food packaging, flame retardants, fuel cells, batteries, capacitors, nanoceramics, lights, material fabrication, manufacturing methods, reinforcement for composites, cement and other materials, medical diagnostic applications, medical therapeutic devices or therapies, tissue engineering, such as scaffolds for bone or tissue repair, potable waters, industrial process fluids, food and beverage products, pharmaceutical and biological agents, tissue imaging, medical therapy delivery, environmental applications, such as biodegradable compounds and the like.

The nanoparticles described herein generally have at least one dimension less than about 20 microns. In some embodiments, the nanoparticles have at least one dimension less than 1 micron (i.e., diameter, width, height, or the like depending on the cross-sectional shape of the fiber). In various embodiments, each individual nanoparticle may be a small particle that ranges between about 1 to about 1000 nanometers in size, preferably between about 1 to about 650 nanometers. The particle size of at least half of the particles in the number size distribution may measure 100 nanometers or below. The majority of the nanoparticles will typically be made up of only a few hundred atoms. The material properties change as the size of the nanoparticles approaches the atomic scale. This is due to the surface area to volume ratio increasing, resulting in the material's surface atoms dominating the material performance. Owing to their very small size, nanoparticles have a very large surface area to volume ratio when compared to bulk material, such as powders, plate, sheet or larger fibers. This feature enables nanoparticles to possess unexpected optical, physical and chemical properties, as they are small enough to confine their electrons and produce quantum effects.

In other embodiments, the nanoparticles comprise mini-fibers or nanofibers that have at least one dimension between about 1 micron to about 20 microns. For example, a mini-fiber or nanofiber having a diameter or width less than a micrometer and a length greater than 1 micrometer is a nanoparticle as used herein. In an exemplary embodiment, the mini fibers have at least one dimension of about 5 microns. The nanoparticles may have a continuous length, or the nanoparticles may have discrete length, such as 1 to 100,000 microns, preferably between about 5 to 10,000 microns, or between about 5 to about 1,000 microns, or about 100 to about 600 microns.

In certain embodiments, the nanoparticles are dispersed “in depth” within the substrate. As used herein, the term “in depth” means that the nanoparticles are dispersed beyond a first surface of the fiber layer such that at least some of the nanoparticles are disposed between first and second opposing surfaces into the internal structure of the filter media. In certain embodiments, the nanoparticles are dispersed throughout substantially the entire media from the first surface to the opposing second surface. In other embodiments, the nanoparticles are dispersed through a portion of the media from the first surface to a location between the first and second surfaces.

In some embodiments, the nanoparticles are distributed three-dimensionally in space relative to the supporting fiber, which may increase fiber surface area and micro-volumes within the filter media. The three-dimensional distribution also provides resistance against complete blockage of a particular portion of the filter media, which is particularly useful in filter media as it allows fluid (e.g., air and other gases) to pass through the filter, thereby reducing the overall liquid throughput across the filter.

In other embodiments, the nanoparticles are disposed in a density gradient across the thickness of the fiber layer such that a higher density of nanoparticles is disposed near one surface than the opposite surface, or a higher density of nanoparticles is disposed on the surfaces as compares to the middle section of the fiber layer. The density gradient may be substantially linear, it may reduce in a series of discrete steps, or the gradient may be random (i.e., a generally reduction in density that is not linear or stepped). This density gradient provides a number of advantageous features for certain applications, such as filters (as discussed below).

The nanoparticles or mini fibers are bonded to the fibers within the substrate, or at least some of the nanoparticles are bonded to at least some of the fibers. In certain embodiments, the substrate or filter media may include a binding agent or binding material, such as an adhesive or binder, to facilitate the bond between the fibers and/or the retention of the nanoparticles in the membrane so that the nanoparticles can adhere to the fibers, or otherwise be retained by the fibers, within the substrate to form a stable matrix. The binding agent or binding material is preferably present in relatively small amounts to bond the individual nanoparticles to fibers throughout the substrate.

The binding agent may comprise a variety of non-soluble adhesives. Suitable non-soluble adhesives include, but are not limited to polyurethane, epoxy, polyimide, starch, dextrin, latex, acrylonitrile, Polyvinyl alcohol, polyvinyl acetate, polyvinyl chloride, acrylic, ethylene-vinyl acetate, polyolefins, phenol formaldehyde resins, urea formaldehyde, polysulfides, cyanoacrylate. Binding agents could be in solution, emulsion, suspension, hot melt, curable, neat, and/or a combination.

In some embodiments, an adhesive resin is used and the adhesive resin may undergo cross-linking after the coating of the adhesive on the substrate. Adhesion (water/solvent resistance) may be promoted by self-crosslinking as the solvent in the adhesive formulation evaporates or by heat activation during drying process. In the case of certain adhesives, crosslinking can be accomplished through high energy wavelengths of electromagnetic radiation including, but not limited to. RF, UV, or e-beam. The amount of adhesive can be controlled by adjusting the nozzle size of spray coater 140 or controlling the flow rate of the adhesive composition. The binding agent can be applied using spray nozzles, dip coating, or other methods.

In some embodiments, the binding agent or binding material may include a surfactant to lower the surface or interfacial tension of the binding agent, thereby increasing its dispersion and wetting properties and allowing the binding agent to more easily penetrate into the depth of the membrane. Suitable surfactants for use with the adhesives disclosed herein include nonionic, anionic, cationic and amphoteric surfactants, such as sodium stearate, 4-(5-dodecyl)benzenesulfonate, sodium dodecylbenzene sulfonate wetting agents, docusate (dioctyl sodium sulfosuccinate), alkyl ether phosphates, benzalkonium chloride c (BAC), perfluorooctanesulfonate (PFOS) and the like.

In some embodiments, the membrane includes its own binder composition. In these embodiments, the binding agent or binding material may, or may not, be added to the membrane. In one such embodiment, the substrate comprises biocomponent fibers, wherein one of the components comprises an outer sheath at least partially surrounding an inner core (see FIGS. 5A and 5C).

The sheath may comprise a material that bonds to the nanoparticles. For example, the sheath may comprise a material that becomes tacky and/or fluid upon heating and/or drying. During the heating/drying step (discussed below), the sheath part of the fiber is heated up to its melting point until it becomes tacky and/or fluid to bond the nanoparticles to the substrate. In a preferred embodiment, bonding and drying take place at the same time.

The nanoparticles may comprise any suitable material, such as glass, biosoluble glass, ceramic materials, acrylic, carbon, metal, such as alumina, polymers, such as polyethylene, high density polyethylene (HDPE) low density polyethylene (LDPE) nylon, polyethylene terephalate, polypropylene (PP), polybutylene (PBT), ethylene polyester (PET), polylactic acid (PLA), polyamide (PA), polyvinyl chloride (PVC), polyolefin, polyacetal, polyester, cellulous ether, polyalkylene sulfide, poly(arylene oxide), polysulfone, modified polysulfone polymers and polyvinyl alcohol, polyamide, polystyrene, polyacrylonitrile, polyvinylidene chloride, polymethyl methacrylate, polyvinylidene fluoride and any combination thereof.

In some embodiments, nanoparticles may be produced as bicomponent segmented pie and islands in the sea. Then filaments are drawn so much so that submicron filaments are obtained. Continuous filament nanoparticles are cut according to desired length, preferably between about 100 to about 10000 microns.

In some embodiments, nanoparticles are absorbents and adsorbents. In some embodiments, nanoparticles are activated carbon fibers or activated carbon powders. In some embodiments, nanoparticles are catalytic particles or catalytic fibers. In some embodiments, nanoparticles can be obtained by feeding a submicron fiber fibrous in a shredder or a crusher or edge trimmer machine where bonded fibrous gets in and shortcut fiber comes out. For instance, low weight biocomponent meltblown or nano meltblown fabric can be fed into a shredder and submicron nanoparticles can be obtained.

In some embodiments, different nanoparticles may be mixed. For examples, nanoparticles and nanobeads can be mixed. Two different nanoparticles with different melting points can also be mixed so that lower melting point nanoparticle can act as binder for higher melting point nanoparticles. Nanoparticles with different diameters and different lengths can be mixed as well.

In some embodiments, nanoparticles are chosen from environmentally sustainable raw materials. Nanoparticles may compromise bio soluble glass nanoparticles, biodegradable nanoparticles, compostable nanoparticles, or recyclable compositions.

Nanoparticles of different types can be combined. Some of the nanoparticles can be functional nanoparticles. For example, the functional nanoparticles may include activated carbon and/or antimicrobial material deposited onto and/or attached to the fibers in the filter media. This may improve the gas absorption efficiency of the fibers and the effectiveness of killing bacteria. In addition, a fibrous product of a microfiber fibrous with nanoparticles of glass and carbon deposited into it would provide filtration and odor-removing functionality as a filter medium.

The substrate may comprise a structure of individual fibers or threads which are interlaid, interlocked or bonded together. For example nonwoven fabrics may include sheets or web structures bonded together by entangling fiber or filaments (and by perforating films) mechanically, thermally, or chemically. They may be substantially flat, porous sheets that are made directly from separate fibers or from molten plastic or plastic film. Examples of suitable nonwoven materials include, but are not limited to, fibers, layers or webs that are meltblown, spunbond or spunlace, gradient spunbond, thermally bonded, bonded carded, air-laid, wet-laid, cellulose wet-laid, glass wet-laid, synthetic wet-laid, composite wet-laid, co-formed, needlepunched, stitched, hydraulically entangled, hydroentangled, ultrasonically bonded or the like. In all of the above examples, the fibers may be hydroentangled or hydraulically entangled.

In one exemplary embodiment, the web formation is either drylaid (carded), wetlaid or bicomponent spunbond. In a particularly preferred embodiment, the substrate comprises wetlaid bicomponent fibers, such as CoPET/PET or HDPE/PET.

In various embodiments, the substrate may comprise a knitted and/or woven material. The knitted material may comprise any knitting pattern suitable for the desired application. Suitable knitted materials for filter applications include weft-knit, warp knit, knitted mesh panels, compressed knitted mesh and the like. Suitable woven materials for filter applications include textile filter media, such as monofilament fabrics, multifilament fabrics, nylon mesh, polyester mesh, polypropylene mesh and the like. Woven textiles may be used in, for example, mesh filter press cloths, woven filter pads and other die cut pieces, centrifuge filter bags, liquid filter bags, dust collector bags, bed dryer bags, rotary drum filters, filter belts, leaf filters, roll media and the like.

In various embodiments, the filter media preferably has a mean flow pore size of less than about 10 microns. In embodiments, the mean flow pore size of the filter media is less than 5 microns, preferably less than 4 microns, and more preferably about 3.8 microns. The nanoparticles reduce the mean flow pore size of the media, while substantially maintaining the liquid throughput (e.g., bubble point) across the filter. The maximum flow pore size of the filter media is preferably less than about 40 microns, or less than about 25 microns or less than about 20 microns.

The bubble point of the filter is less than about 20 (in/h20) or less than about 15 microns (in/h20). The bubble point is defined herein as the amount of force required to pass liquid through the substrate (i.e., the higher the number, the more difficult it is to pass the liquid therethrough).

In an exemplary embodiment, the membrane has a porosity value of at least 50% or 40%, preferably at least 20% or 5%. Porosity value is defined as the nonsolid or pore-volume fraction of the total volume of the material.

In various embodiments, the substrate comprises a porous membrane. The porous membrane may have a thickness suitable for the particular application. In certain embodiments, the membrane has a thickness of about 0.2 mm to about 5 mm, preferably about 0.5 to about 3 mm.

In some embodiments, the filter media may include a structure comprising shortcut fibers and/or filaments that are intermingled or entangled. A shortcut fiber as used herein means a fiber of finite length. A filament as used herein means a fiber having a substantially continuous length. In some embodiments, the substrate may comprise shortcut coarse, microfibers and/or fine fibers. As used here in a “fine fiber” means fibers having diameter less than 1 micron, a “coarse fiber” means fibers having diameter more than 10 micron, and a microfiber is a synthetic fiber having a diameter of less than 10 microns.

In some embodiments, the nanoparticles are bonded to the fibers via mechanical entanglement. This mechanical bond can be supplemented with an adhesive or binding agent, as discussed in more detail below. In certain embodiments, the nanoparticles are not crimped, i.e., they do not include significant wavy, bent, curled, coiled sawtooth or similar shape associated with the nanoparticle in a relaxed state. In other embodiments, the nanoparticles may have a crimped body structure with a discrete length. For instance, when these crimped nanoparticles having a discrete length are attached to the fiber, they entangle among themselves and also with, onto, and around, the fiber with a firm attachment to form a modified fiber. In other embodiments, the attachment of the nanoparticles to the micron fibers is accomplished via electrostatic charge attraction and/or Van der Waals force attraction between the fibers and the nanoparticles.

Filters, such as liquid filters also provided that include nanoparticles dispersed in depth within the filter. In some embodiments, the filter media may include one or more support layers bonded to the filter media, such as a scrim layer, a plastic netting layer (e.g., polypropylene netting), mesh, screen, flow channel spacers, channel depth layers, rigid mesh plastic tubes, center core supports, outer wraps, protective sleeves, pleat supports or the like. In some embodiments, polymer layers, membranes or films are provided that include one or more apertures for flow of gas or liquid therethrough with nanoparticles disposed in depth within the polymer layer. The nanoparticles may be incorporated into any one of these support layers and/or the filter media that is bonded to these support layers.

For example, the support layer may include a channel depth layer that increases the volumetric filtration capacity while extending the filter media life. The nanoparticles may be incorporated into the channel depth layer. This type of filter media is particularly useful as a gradient structure filter in an automotive fuel filter and is described in more detail in U.S. Pat. No. 9,555,353, the complete disclosure of which is incorporated herein by reference in its entirety for all purposes.

FIG. 1 illustrates a representative filter media, porous membrane or substrate 10 that includes a plurality of fibers 12 and nanoparticles 14 that have manufactured by the systems and methods described above. Substrate 10 has a first surface 16 and a second surface 18 opposing the first surface 16 and defined a width or thickness between first and second surfaces 16, 18. The nanoparticles 14 have been deposited into the substrate through first surface 16. As shown, nanoparticles 14 penetrate through first surface 16 into the “depth” of the substrate 10 between the first and second surfaces 16, 18. In some embodiments, the nanoparticles 14 penetrate from the first surface at least 25% of the width or thickness between the first and second surfaces 16, 18, or more preferably at least about 50% of the thickness. In other embodiments, the nanoparticles 14 penetrate substantially throughout the substrate 10 from first surface 16 to second surface 18.

The nanoparticles 14 preferably comprise individual nanoparticles that have been broken up, separated and isolated from each other prior to dispersion into substrate 10, as discussed above. As such, the nanoparticles 14 are not present in the fibrous product in a layer, and do not have significant clumping or bundles of nanoparticles. This provides a greater dispersion of nanoparticles throughout the substrate, which in some applications, such as gas or air filters, provides a more efficient filtering capacity for filtering out contaminants. In addition, this provides a filter media with a greater area density of nanoparticles in grams per square meter (gsm) within the material or “add-on amount”. The term “add-on amount” is used herein to mean the area density (gsm) of a material, fiber or particle in a thin layer, sheet or film of material.

In certain embodiments, the nanoparticles may comprise an add-on amount of about 0.1 grams/m² to about 20 grams/m^{2.} preferably at least about 2.0 grams/m². The specific add-on amount or area density may depend on the application. For example, Applicant has found that a higher area density or add-on amount will increase the efficiency of the filter media in filtering out contaminants. Thus, the specific add-on amount of nanoparticles may depend on the desired efficiency of a filter media.

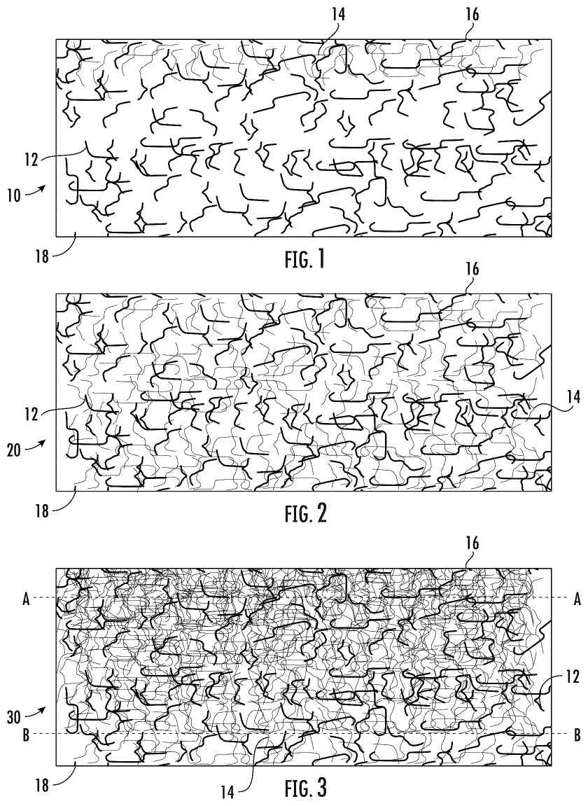

FIG. 2 illustrates a filter media or substrate 20 that includes a plurality of fibers 12 and nanoparticles 24 that have manufactured by the systems and methods described above. As shown, nanoparticles 14 penetrate throughout the entire width of substrate 20 from first surface 16 to second surface 18. In certain embodiments, the nanoparticles 14 are substantially dispersed throughout the fibers 12 of substrate, as shown in FIG. 1n certain embodiments, the density of nanoparticles located at first surface 16 differs by less than 50% of the density of nanoparticles dispersed within the central portion of substrate 20 between surfaces 16, 18. In some embodiments, this difference is less than 25%, preferably less than 10%. In certain embodiments, the amount or number of individual nanoparticles dispersed within the central portion of substrate 20 is at least about 50% of the amount of individual nanoparticles dispersed at or near first surface 16, preferably at least about 75% and more preferably at least about 90%.

In other embodiments, nanoparticles 14 are disposed in a density gradient from first surface 16 to second surface 18. For example, FIG. 3 illustrates a substrate 30 wherein the nanoparticles 14 form a density gradient with a higher density of nanoparticles 14 disposed near first surface 16 than second surface 18. In certain embodiments, the density of nanoparticles located at first surface 16 differs by greater than about 75% of the density of nanoparticles dispersed at second surface 18. In some embodiments, this difference is greater than 50%. In some embodiments, the difference is greater than 25%. In certain embodiments, the amount or number of individual nanoparticles dispersed at or near second surface 18 is less than about 50% of the amount of individual nanoparticles dispersed at or near first surface 16, preferably less than about 25% and more preferably less than about 10%.

The density gradient shown in FIG. 3 may be substantially linear from first surface 16 to second surface 18. Alternatively, the density of the nanoparticles 14 may reduce from first surface 16 to second surface 18 in a series of discrete steps, or the gradient may be random (i.e., a generally reduction in density that is not linear or stepped).

In other embodiments, the nanoparticles may be added into the substrate from both the first and second surfaces 16, 18. In these embodiments, the area density or “add-on amount” at first and second surfaces 16, 18 may be substantially equal to each other, or they may be different depending on the application. In these embodiments, the area density or “add-on amount” that is present in the middle of the substrate is lower than at surfaces 16, 18. For example, the area density in the middle of the substrate may be about 75% of the area density at surfaces 16, 18, or it may be about 50%, 40% or 25%.

The distribution of nanoparticles across the thickness of the filter media can be measured, for example, using imaging techniques. A magnified view of the fibrous product, using an electron microscope or other techniques, taken at a horizontal section of the product at the middle of the thickness of the product can be compared to an image taken at the upper or lower surface of the product, or all three images can be compared, to determine the extent to which the amount of nanoparticles deposited varies. Computerized image analysis processing can be employed. For example, in FIG. 3, a section can be taken at line A-A and a section can be taken at B-B. A top view image of each section can be taken through electron microscope, scanning electron microscopy, and other microscopes. A top view image of the section taken at section A-A, for example, can be compared to a top view image taken at section B-B. The number of microfibers, the number of nanoparticles, or both, in samples of the same two-dimensional size can be assessed and compared. In addition, imaging techniques can be used on three dimensional samples. These techniques can be used to assess the orientation of fibers and other characteristics. These techniques can be used to determine that nanoparticles have been deposited into the depth of the substrate, have been deposited substantially across a significant portion of the substrate, substantially across the entire depth, or across some portion of the depth of the substrate.

The contemplated fibers of the substrate can be manufactured by any method, including, without limitation, the thermally or ultrasonically bonded, cellulose wet laid, glass wet laid, synthetic wet laid, composite wet laid, needle punch, meltblown, air laid, spinneret, gel spinning, melt spinning, wet spinning, dry spinning, islands-in-a sea staple or spunbond, segmented pie staple or spunbond, and others. Such methods are described in U.S. Pat. Nos. 4,406,950, 6,338,814, 6,616,435, 6,861,142, 7,252,493, 7,300,272, 7,309,430, 7,422,071, 7,431,869, 7,504,348, 7,774,077 9,522,357, 9,993,761 and US Patent Publication No. 2009/266,759, the completed disclosures of which are hereby incorporated herein by reference for all purposes.

The fibers contemplated may have many shapes in cross-section, including without limitation, circular, kidney bean, dog bone, trilobal, barbell, bowtie, star, Y-shaped and others. These shapes and/or other conventional shapes may be used with the embodiments to obtain the desired performance characteristics. The fibers in the substrate stay connected to each other through thermal bonds, chemical bonds, by being entangled with one another, through the use of binding agents, such as adhesives, or the like.

The fibers may be artificial or natural fibers. Suitable materials for the fibers include, but are not limited to, metallic fibers, carbon fibers, polypropylene (PP), polyesters (PET), PEN polyester, PCT polyester, polybutylene (PBT), ethylene polyester (PET), polylactic acid (PLA), polyamide (PA),co-polyamides, polyethylene, high density polyethylene (HDPE), low density polyethylene (LDPE), cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluorocthylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene or any combination thereof. Other conventional fiber materials are contemplated.

The fibers may include fibers of different sizes, with the fibers generally having diameters ranging from about 1 to about 1000 microns with lengths ranging from about one half to three inches. The fibers may be configured as a gradient density media in which the pore size decreases from the upper surface of the filter (upstream) to the lower surface (downstream) to increase capture efficiency and dust holding capacity. This configuration also allows for the dispersion of different amounts of nanoparticles to the filter media at different depths. For example, the upstream side of the filter media may have the largest fiber size to allow for more void space and a greater density of nanoparticles, while the downstream side of the filter media has fibers with smaller sizes to provide a lower density of nanoparticles. Alternatively, this structure may be reversed to provide a greater density of nanoparticles in the downstream portion of the filter media.

The fibers in the media may stay connected to other fibers by being thermally bonded, chemically bonded or entangled with one another. Bicomponent fibers may be used, particularly with mechanical filtration, and these are formed by extruding two polymers from the same spinneret with both polymers contained within the same filament. Suitable materials for bicomponent fibers include, but are not limited to, polypropylene (PP)/polyethylene (PE), polyethylene terephthalate (PET)/polypropylene (PP) and the like.

In some embodiments, the substrate may comprise a “high loft” filter media comprising spunbond or air through bonded carded fibers. As used here in the term “high loft” means that the volume of void space is greater than volume of the total solid. In air through bonded carded nonwoven fibers, the loftiness of a substrate can be controlled by various means known to those of skill in the art. For example, loftiness can be increased by applying less compression force onto the media during bonding. In another example, a high loft nonwoven material can be manufactured with fibers having larger thicknesses, such as thicknesses greater than 3 denier, e.g., 5 denier or greater, 6 denier or greater (discussed in more detail below). In other embodiments, the loftiness may be increased by using eccentric biocomponent fibers, as shown in FIG. 5C and discussed in more detail below.

In certain embodiments, the fibers may include a silicone-based coating to improve the efficiency of the filter media at capturing contaminants, particularly contaminants in the E2 and E3 particle group range. The silicone-based coating may comprise a reactive silicone macroemulsion. The silicone emulsion may comprise, for example, dimethyl silicone emulsions, amino type silicone emulsions, organo-functional silicone emulsions, resin type silicone emulsions, film-forming silicone emulsions, or the like. In one embodiment, the reactive silicone macroemulsion comprises an amino functional polydimethylsiloxane and/or a polyethylene glycol monotridecyl ether. Suitable silicone coatings are described in commonly assigned U.S. patent application Ser. No. 14/464,484, filed Sep. 11, 2023, the complete disclosure of which is incorporated herein by reference.

The filtration media may comprise a charge additive to modify the charge of the fibers and increase the stability and/or duration of the charge in the filter. This increases the overall filtration efficiency of the filter without compromising other important characteristics of the filters, such as longevity, dust holding capacity, and the bubble point or flow through the filter. Suitable charge additives for charging are described in commonly assigned Provisional Patent Application Ser. No. 63/410,731, filed Sep. 28, 2022, the entire disclosures of which are hereby incorporated by reference herein for all purposes.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in linear mass density of fibers. In some embodiments, the fibers may have a linear density of about 1 denier to about 10 denier. The nanoparticles are fibers having at least one dimension in the range of about 1 to about 1,000 nanometers or about 1 to about 100 nanometers. The dimensions described above fibers and nanoparticles may be a diameter or a width, depending on the shape of the fiber or nanoparticle.

In certain embodiments, a filter media may include at least two different fiber thicknesses or linear densities to provide at least two different layers of filter within the same filter media. For example, in some cases, one portion of the filter media will include fibers with linear densities greater than 3 denier, for example, 5 denier or greater or 6 denier or greater. The other portion of the filter media will comprise fibers with more standard linear densities of 3 denier or less. This dual-layer filter media creates a first filter portion that filters contaminants primarily with nanoparticles that have a high density within the larger thickness fibers and a second filter portion that filters contaminants primarily with the fibers having lower linear densities, although both portions may include nanoparticles dispersed throughout the fibers. In certain embodiments, the filter media may include three or more separate portions or layers with different denier fiber ranges within each portion.

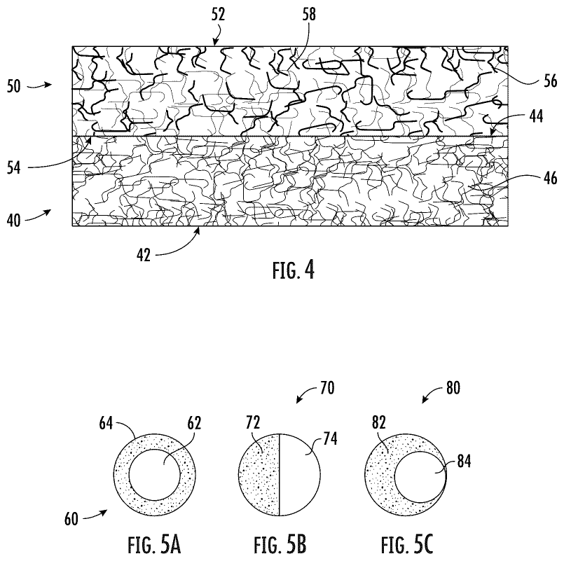

FIG. 4 illustrates a dual layer filter media that includes a first substrate 40 having a first surface 42 and a second surface 44 opposing the first surface; and a second substrate 50 having a first surface 52 and a second surface 54 opposing the first surface. Second surface 44 of substrate 40 is bonded to second surface 54 of first substrate in any manner known to those skilled in the art. First substrate 40 contains fibers 46 of relatively smaller linear density, e.g., on the order of 3 denier or less. Second substrate 50 contains fibers 56 of relatively larger linear densities, e.g., on the order of 3 denier or greater, such as 5 denier, 6 denier or larger. Second substrate 50 also includes individual nanoparticles 58 dispersed throughout and bonded to fibers 56 and/or retained by second substrate 50. First substrate 40 may, or may not, also include nanoparticles.

First substrate 40 is configured to filter contaminants primarily with fibers 46, although as mentioned previously, first substrate 40 may also include nanoparticles. Second substrate 50 is configured to filter contaminants with both fibers 56 and nanoparticles 58.

In some embodiments, the substrate may compromise additives, such as antibacterial and/or antiviral compositions such as silver, zinc, copper, organosilicone, tributyl tin, organic compounds that contain chlorine, bromine, or fluorine compounds.

The fibers may include biocomponent fibers that include two or more different fibers bonded to each other. The fibers may comprise the same material, or different materials.

In certain embodiments, the filter media (i.e., the fibers and/or the nanoparticles) may be electrostatically charged such that, for example, contaminants are captured both with mechanical and electrostatic filtration. The bond between the fibers and the nanoparticles may also be enhanced by electrostatically charging the nanoparticles, the fibers or both. For example, in certain embodiments, the fibers are electrostatically charged such that mechanical filtration can be achieved by nanoparticles while electrostatic filtration can be achieved through electret substrate. The electrostatic or electret substrate could be high loft triboelectric filter media made by carding and needling. In one of the embodiments, the nanoparticles are preferably deposited into the substrate before needling and then both electrostatic fibers and nanoparticles are needled together.

The substrate, the nanoparticles, or both can be electrostatically charged using triboelectric methods, corona discharge, electrostatic fiber spinning, hydro charging, charging bars or other known methods. Corona charging is suitable for charging monopolymer fiber or fiber blend, or fabrics. Tribocharging may be suitable for charging fibers with dissimilar electronegativity. Electrostatic fiber spinning combines the charging of the polymer and the spinning of the fibers as a one-step process. Suitable charge additives for triboelectric charging are described in commonly assigned Provisional Patent Application Ser. No. 63/410,731, filed Sep. 28, 2022, the entire disclosures of which are hereby incorporated by reference herein for all purposes.

The nanoparticles can be chosen with different triboelectric properties relative to the fibers in order to use a triboelectric effect to enhance particle removal. With this method, the generated nanoparticles are formed in an electrical field and are less subject to contamination by chemicals that may moderate the triboelectric effect. Nanoparticles with different adsorption properties or surface charge characteristics than the coarse fibers can also be used, e.g. in oil or water filtration. This difference can be used to enhance or create localized electrical field gradients within the filter media to enhance particle removal. The nanoparticles and coarse fibers may have different wetting characteristics.

In certain embodiments, the filter media may be included in a thin film or layer that includes apertures, pores or perforations. The apertures may be embossed in a pattern (such as circular, diamond shaped, hexagonal, oblong, triangular, rectangular, etc.) and then stretched until apertures form in the thinned out areas created by the embossing. Such an apertured substrate can be formed from many polymers, such as polypropylene, polyethylene, high density polyethylene (“HDPE”) and the like. The polymer layer may, for example, comprise an extruded film. An apertured film is available commercially and is marketed under the trademark Delnet®. The substrate is provided in a roll and nanoparticles are deposited into the substrate in a roll to roll process.

The fibers may include biocomponent fibers that include two or more different fibers bonded to each other. The fibers may comprise the same material or different materials.

FIGS. 5A-5C illustrate different examples of biocomponent fibers that may be used with the porous membranes disclosed herein. FIG. 5A illustrates a fiber 60 having a core fiber 62 and a surrounding sheath fiber 64. In this embodiment, the core 62 is substantially co-centric with the sheath. FIG. 5B illustrates a biocomponent fiber 70 having first and second fibers 72, and 74 that are disposed side-by-side with each other. FIG. 5C illustrates a biocomponent fiber 80 having a core fiber 82 and a sheath fiber 84. In this embodiment, core 82 is eccentric relative to the longitudinal axis of sheath 84, which increases the overall loftiness of the biocomponent fiber. Of course, other configurations are possible. For example, the core may comprise shapes other than circular, such as dog-bone shaped, square, triangular, diamond or the like. Alternatively, the fiber may comprise multiple cores, or it may be split into three, four or more quadrants.

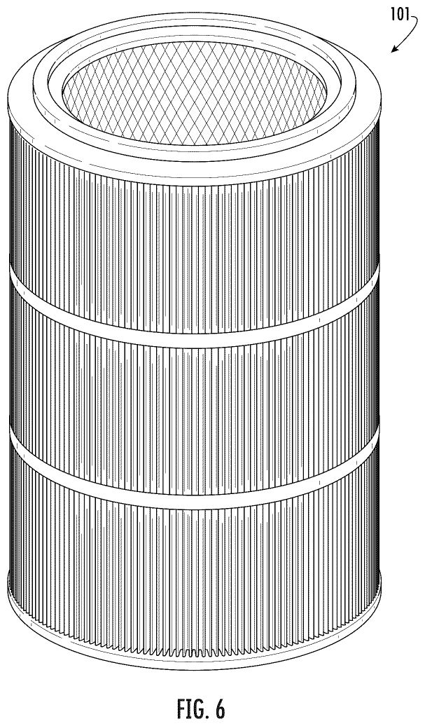

FIG. 6 illustrates a representative liquid filter 101 produced with various embodiments of porous membranes. The porous membrane is rolled into a cylinder, cone, or other suitable shape and may be used in applications, such as gas turbine and compressor air intake filters, panel filters and the like. A cartridge is a tubular filter medium that is encased inside a housing. The direction of flow in a cartridge filter is typically from outside to the insides of the cartridge. Cartridges are usually made from synthetic or natural fibers and small metal wires. A core, made of stainless or tin-plated steel or polypropylene, is present on the axis of the tubular cartridge to support the media material. A purer filtrate is collected at its core.

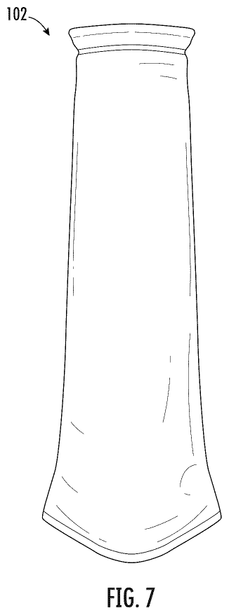

FIG. 7 illustrates a representative bag filter 102 produced with various embodiments of filter media and/or porous membranes as described herein. Bag filter 102 includes a porous membrane having staple fibers and nanoparticles dispersed through the depth of the substrate. Bag filters are one of the most popular filtration equipment. In this equipment, the process liquid passes through a permeable bag perforated with microscopic holes which act as the filter medium. The solid particles larger than the holes are entrapped and accumulated inside the bag. Its end has a sealing ring, usually made from stainless steel or plastic, to secure the bag inside the filtration vessel.

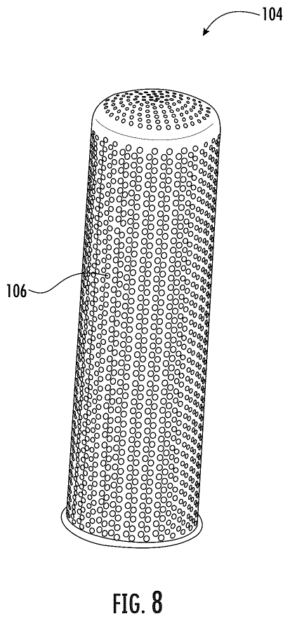

FIG. 8 illustrates a representative metal filter media 104 produced with various embodiments of filter media and/or porous membranes as described herein. Filter media 104 comprises a metal screen or perforated sheet 106 made from stainless steel, copper or aluminum. Filter media 104 is particularly useful for filtering liquids at elevated temperatures and high flow rates, and for corrosive liquids.

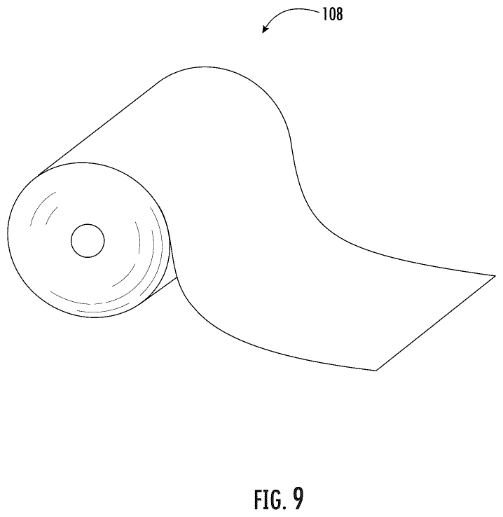

FIG. 9 illustrates a representative synthetic filter 108 produced with various embodiments of filter media and/or porous membranes as described herein. Synthetic filter 108 comprises a polymeric material, such as polyester, nylon, polypropylene and/or fluoropolymers, such as PVDF and PTFE. The polymer material may be a fabric with monofilaments or multifilaments.

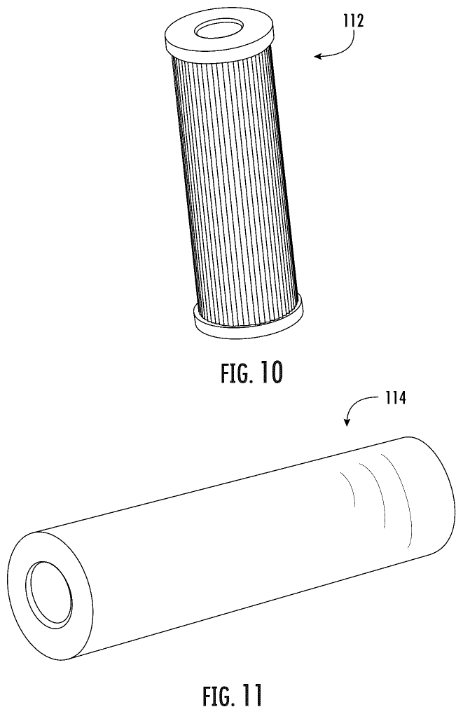

FIG. 10 illustrates a representative pleated filter cartridge 112 produced with various embodiments of filter media and/or porous membranes as described herein. Filter cartridge 112 is particularly useful in surface filtration and may be constructed by pleating the media bonded at its ends to provide a larger filtration area for a minimal volume.

FIG. 11 illustrates a representative spun-bonded filter cartridge 114 produced with various embodiments of filter media and/or porous membranes as described herein. Filter cartridge 114 is particularly useful for depth filtration and may be constructed by thermally bonding the fibers together while maintaining a gradual density gradient. This increases the durability and the strength of the cartridge.

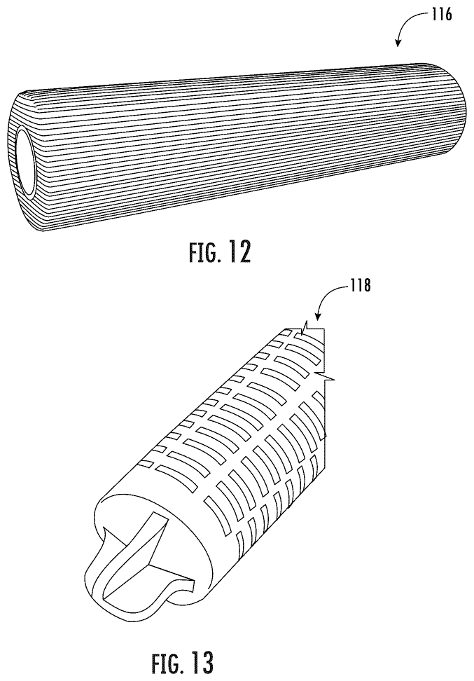

FIG. 12 illustrates a representative wound cartridge 116 produced with various embodiments of filter media and/or porous membranes as described herein. Wound cartridge 116 is particularly useful for depth filtration and is constructed by spinning the strand around the core to establish the layers of the filter and creating density gradients gradually increasing from the outer surface to the inner surface.

FIG. 13 illustrates a membrane filter cartridge 118 produced with various embodiments of filter media and/or porous membranes as described herein. Filter cartridge 118 is particularly useful in the food and beverage, pharmaceutical, UPW, and semiconductor industries. Filter cartridge 118 may comprise PTFE, PES, PVDF and/or nylon and may have a pleated filter construction. The folded structure offers each pleated membrane filter cartridge a large filter area and high dirt holding capacity, hence efficiently increasing the service time.

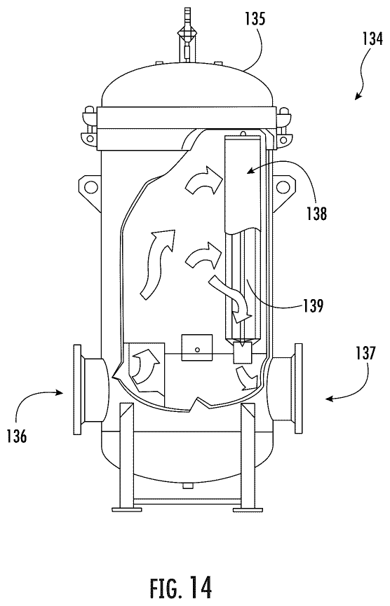

FIG. 14 illustrates an industrial liquid filter device 134 that includes various embodiments of filter media and/or porous membranes as described herein. As shown, filter device 134 includes a generally cylindrical outer metal housing 135 with an inlet 136 for receiving unfiltered liquids and an outlet 137 for discharging filtered liquids. A filter media cartridge 138 extends through an interior of housing 135 such that liquid must flow through the cartridge 138 before exiting the outlet 137 of housing 135. Filter cartridge 138 comprises a filter media 139 that includes a substrate of fibers with nanoparticles incorporated therein, as described above.

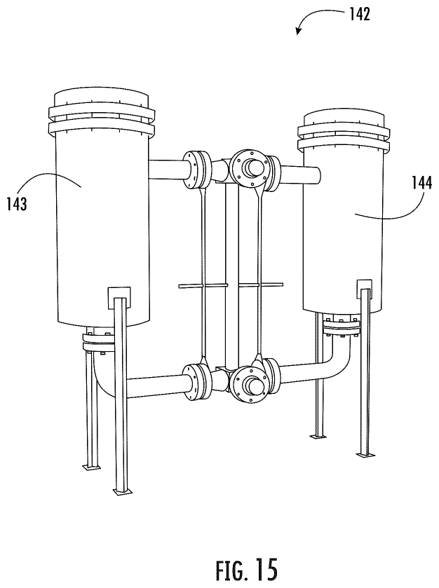

FIG. 15 illustrates a multi-bag filter 142 that includes various embodiments of filter media and/or porous membranes as described herein. Filter 142 is a small scale filter that is particularly useful in homes, offices and laboratories. As shown, filter 142 includes first and second housings 143, 144 each including a bag filter therein (not shown), such as the bag filter shown in FIG. 7. Filter 142 may also be used as a pre-treatment to a downstream process, wherein removal of solids is crucial in achieving product quality and safety and in maintaining the efficiency of the downstream equipment. Filter 142 may be used in a pipeline, pumping system or in a manufacturing process intended for human consumption, such as beverages and drinking water.

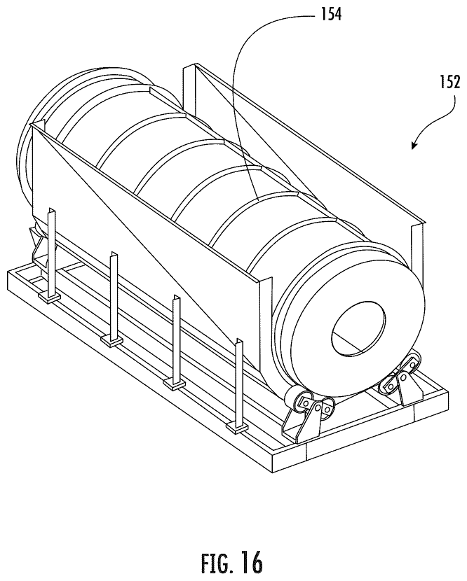

FIG. 16 illustrates a rotary drum filter 152 that includes various embodiments of filter media and/or porous membranes as described herein. Filter 152 is particularly useful as an industrial filtration device for the filtration of liquid streams with high solids concentration in a continuous process. As shown, filter 152 comprises a drum 154 under vacuum pressure that is partially submerged in the slurry. The lateral surface of drum 154 in includes one or more filter media (not shown). As drum 154 rotates, the liquid is drawn to the vacuum and the solid is retained on the surface of drum 154. Drum 154 may further include a scraping system to discharge the cake to prevent build-up on the filter media.

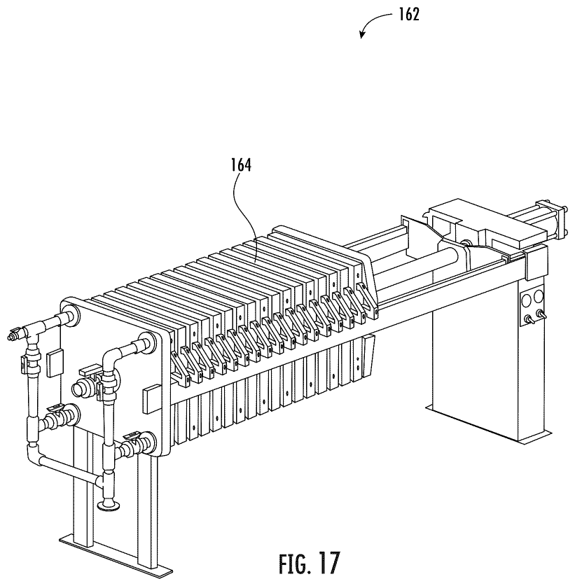

FIG. 17 illustrates a filter press 162 that includes various embodiments of filter media and/or porous membranes as described herein. Press 162 is particularly useful as industrial filtration equipment used in the filtration of liquid streams with high solids concentration in a batch process. Press 162 comprises a plurality of plates 164, each including a filter media (not shown) that includes a fiber substrate with nanoparticles incorporated therein, as described above. The slurry is pumped through plates 164 and then de-watered under high pressure.

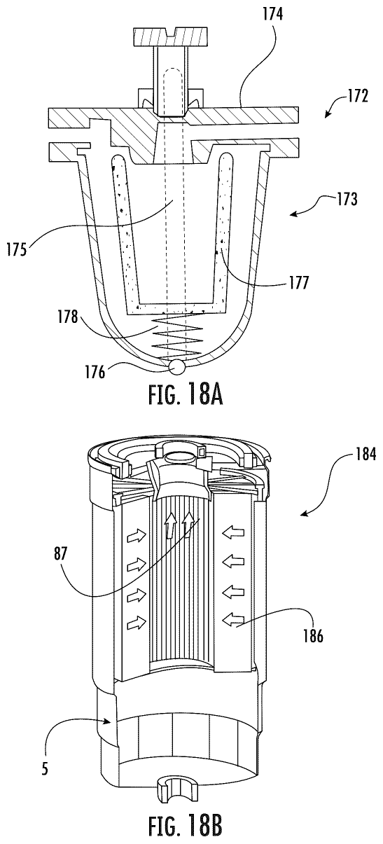

FIG. 18A illustrates one embodiment of a fuel filter 172 that includes various embodiments of filter media and/or porous membranes as described herein. As shown, filter 172 includes a main housing 173 that protects the internal components of filter 172, typically made of steel. Housing 173 typically includes pressure therein to prevent overflow. Housing 173 comprises a base plate 174 that connects housing 173 to a mounting assembly (not shown) to install the filter, prevent fuel leakage and maintain pressure within filter 172. Housing 173 further includes a center tube 175 that acts as a support for filtration and prevents it from falling inward. Tube 175 also functions as an outlet for the filtered fuel and typically comprises a material stronger than steel. An end cap 176 hold a filter media 177 in place and is attached to filter media 177 with a suitable adhesive. End cap 176 further serves to prevent leaks. A compression spring 178 holds the internal components under varying pressures. Filter media 177 includes a substrate that incorporates nanoparticles therein, as described above. The substrate typically comprises a cellulose or synthetic material. Filter 172 may further include a drain valve, that provides a mechanism for fuel to bypass filter media 177, a water sensor for detecting the presence of water in diesel fuel that is fitted within a fuel strainer.

FIG. 18B illustrates a fuel filter 184 that is particularly useful for a vehicle and may be connected between the fuel pump and the carburetor of the vehicle. Filter 184 serves to catch any water or foreign particle that was not filtered out in the fuel pump sedimental bowl and strainer in the fuel tank filter unit. Filter 184 comprises a housing 185 with a multilayer filter media 186 surrounding a double beading 187. Filter media 186 may be constructed of a suitable ceramic material. Fuel entering housing 185 passes through ceramic filter media 186, which separates the foreign particles. Filtered fuel exists filter media 186 and water and sediments are collected in the bowl, which can be removed for cleaning.

FIG. 19 illustrates a CMP filter 192 that includes various embodiments of filter media and/or porous membranes as described herein. Filter 192 is particularly useful in a semiconductor manufacturing process to remove large slurries and maintain the desired slurry formulation and chemistry and/or to level uneven areas by combining a chemical (acidic or basic) slurry of micro-abrasives with mechanical force provided by polishing. In multilevel metallization processes, as each new metal layer gets added it magnifies the imperfections in the layer just below it. CMP allows for subsequent photolithography processes to take place with greater accuracy. Filter 192 includes one or more filter medias capable of filtering ILD, STI, tungsten, bulk copper, barrier copper and other slurries to reduce micro scratches, arc scratches, chatter marks and to increase process stability.

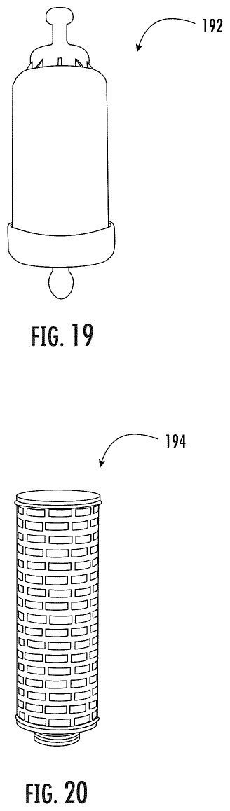

FIG. 20 illustrates a water filter 194 that includes various embodiments of filter media and/or porous membranes as described herein. Filter 194 is designed to ensure the purity of acids, bases and solvents used in a semiconductor manufacturing process. For example, filter 194 may be particularly useful in removing colloidal contaminants, such as silica bacterial breakdown products in the manufacturing process. Filter 194 mitigates the harmful effects of metal ionic and particulate contamination.

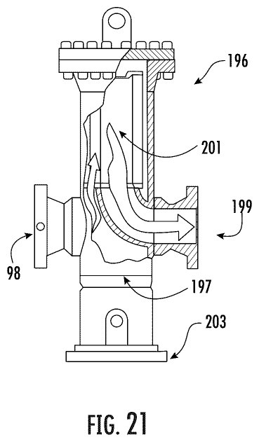

FIG. 21 illustrates a gas pipeline filter 196 for filtering dry gas that includes various embodiments of filter media and/or porous membranes as described herein. Pipeline filter 196 comprises a housing 197 having gas inlet 198 and a gas outlet 199 with a reloadable filter cartridge 201 positioned within housing 197 between the inlet 198 and the outlet 199. Filter 196 further includes a drain 203 and is configured for installation on a pipeline to remove large solid impurities in the fluid to ensure that the equipment, such as compressors, pumps, meters and the like, can be operated normally and safely.

Other types of liquid filters that may be developed with the materials disclosed herein include conical filter cartridges, spun-bonded cartridges, square-end cap filter cartridges, activated carbon filter cartridges, reverse osmosis membrane cartridges, alkaline filter cartridges, battery separators, ultraviolet filter cartridges, pocket filters, V-bank compact filters, panel filters, flat cell filters, pleated or unpleated bag cartridge filters, clean-in-place (CIP) filters and the like. A more complete description of different filters that may include the filter media described herein may be found in U.S. patent application Ser. No. 18/297,217, filed Apr. 7, 2023 and U.S. Provisional Patent Application Ser. No. 63/517,656, filed Aug. 4, 2023, the complete disclosures of which are incorporated herein by reference in their entirety for all purposes.

Systems, devices and methods are provided herein for producing the filter media, porous membrane and the products containing the filter media or porous membrane (e.g., liquid filters). Systems and methods are also provided for isolating the individual nanoparticles in a gaseous medium, such as air, helium, nitrogen, oxygen, carbon dioxide and the like (instead of a liquid) and are capable of being dispersed into another product, film, layer or substrate via a gas stream, aerosol, vaporizer, spray or other suitable delivery mechanism.

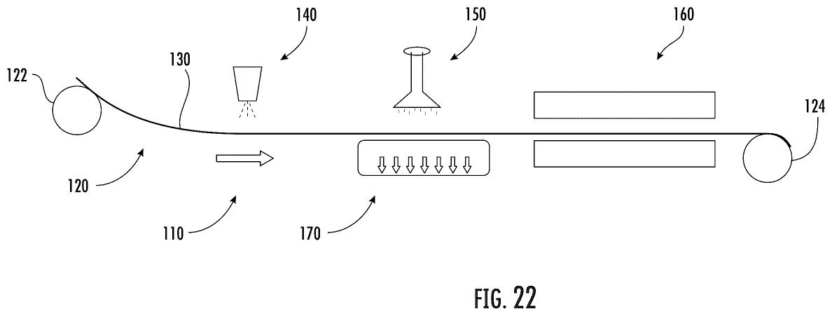

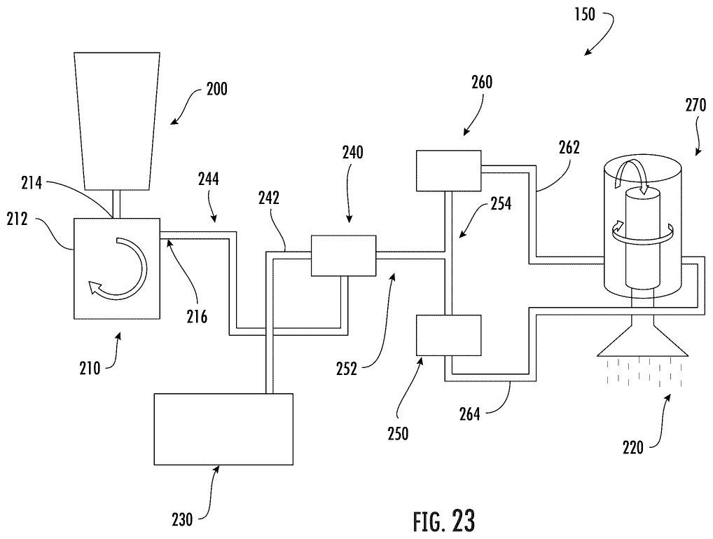

FIG. 22 schematically depicts an overall system 110 for manufacturing the filter medias and other products described herein. As shown, system 110 comprises a feeder 120 for advancing a layer 130 of fibers or other material through the manufacturing process. System 100 further includes a coater 140, a nanoparticle dispersal system 150 and a heating and/or drying device 160. In certain embodiments, system 100 further includes a vacuum or other source of negative pressure 170 underlying substrate 130 opposite fiberization system 150.

In one embodiment, feeder 120 comprises a winder 122 on the downstream end of the process and an unwinder 124 on the upstream end that continuously winds fiber layer 130 through system 100. In certain embodiments, feeder 120 may further comprise a support surface (not shown) extending between the winders for supporting fiber layer 130 as it moves downstream through system 100. In other embodiments, the fiber layer unwinds directly from unwinder 124 to winder 122 without another support surface.

Coater 140 is configured to spray droplets of a binding agent or binding material, such as an adhesive or binder, onto fiber layer 130 so that the nanoparticles can adhere to fibers within layer 130 to form a stable matrix. The binding agent is preferably present in relatively small amounts to bond the individual nanoparticles to fibers throughout layer 130. In a preferred embodiment, coater 140 comprises a spray nozzle sized to generate adhesive droplets having a diameter of about 20 to 30 microns to increase the penetration depth of the adhesive through layer 130. Of course, the droplet size may be affected by numerous other parameters, including air pressure, volume of air, temperature of air, humidity, spray horn design, rheology/viscosity of the adhesive, the carrier and the like.

Of course, it will be recognized that coating the substrate with a binding agent or binding material may be achieved with other coating methods, which include ultrasonic spraying, dip coating, spin coating, gravure coating, kiss roll coating, screen coating, powder coating, electrostatic, sputter coating, or similar coating techniques.

In some embodiments, an adhesive resin is used and the adhesive resin may undergo cross-linking after the coating of the adhesive on fiber layer 130. Adhesion (water/solvent resistance) may be promoted by self-crosslinking as the solvent in the adhesive formulation evaporates or by heat activation during drying process. In the case of certain adhesives, crosslinking can be accomplished through high energy wavelengths of electromagnetic radiation including, but not limited to. RF, UV, or e-beam. The amount of adhesive can be controlled by adjusting the nozzle size of spray coater 140 or controlling the flow rate of the adhesive composition.

In some embodiments, the binding agent may include a surfactant to lower the surface or interfacial tension of the binding agent, thereby increasing its dispersion and wetting properties and allowing the binding agent to more easily penetrate into the depth of the substrate. Suitable surfactants for use with the binding agents disclosed herein include nonionic, anionic, cationic and amphoteric surfactants, such as sodium stearate, 4-(5-dodecyl)benzenesulfonate, sodium dodecylbenzene sulfonate wetting agents, docusate (dioctyl sodium sulfosuccinate), alkyl ether phosphates, benzalkonium chloride (BAC), perfluorooctanesulfonate (PFOS) and the like.

In some embodiments, spray coater 140 is located upstream of nanoparticle dispersal system 150 so that the binding agent is sprayed before the nanoparticles are deposited. In other embodiments, spray coater 140 is located downstream of system 150 so that the binding agent can be sprayed after nanoparticle deposition. In other embodiments, systems 100 includes two spray coatings; one located upstream from system 150 and a second spray coater (not shown) located downstream of system 150 to coat fiber layer 130 with a secondary binding agent after deposition of the nanoparticles.

In some embodiments, there is more than one nozzle head with each spray coater 140. The nozzle heads may, for example, be disposed in series for better uniformity or to increase fiber spraying width. Alternatively, the nozzle heads may be located in parallel, i.e., across the width of the substrate, to ensure that the binding agent is coated throughout the width of the substrate.

In a preferred embodiment, a source of negative pressure or a vacuum (not shown) is disposed under fiber layer 130 opposite spray coater 140 to increase the penetration depth and uniformity of the binding agent. The source of negative pressure may be any suitable suction device that draws binding agents through substrate, such as a suction pump or the like.

In some embodiments, the fiber layer includes its own binder composition. In these embodiments, the binding agent may, or may not, be added to the fiber layer. In one such embodiment, the fiber layer comprises biocomponent fibers, wherein one of the components comprises an outer sheath at least partially surrounding an inner core. In certain embodiments, sheath and core may be substantially co-centric with each other. In other embodiments, the core may be eccentric with the sheath. In other embodiments, the core and sheath may lie side-by-side with each other. Of course, other configurations are possible. For example, the core may comprise shapes other than circular, such as dog-bone shaped, square, triangular, diamond or the like. Alternatively, the fiber may comprise multiple cores, or it may be split into three, four or more quadrants.

The sheath may comprise a material that bonds to the nanoparticles. For example, the sheath may comprise a material that becomes tacky and/or fluid upon heating and/or drying. During the heating/drying step, the sheath part of the fiber is heated up to its melting point until it becomes tacky and/or fluid to bond the nanoparticles to the fiber layer. In a preferred embodiment, bonding and drying take place at the same time within drying device 160.

FIG. 23 schematically depicts one embodiment of a nanoparticle dispersal system 150 (or fiberization system) for converting groups of nanoparticles into individual nanoparticles. The term “fiberization” as used herein means converting (e.g., opening up, separating, isolating and/or individualizing) clusters, clumps or other groups of nanoparticles that may, or may not, be entangled with each other into individual nanoparticles having at least one dimension less than 1 micron.

As shown, system 150 includes a feeder 200, such a hopper, for introducing the larger or macro clusters/clumps of nanoparticles into system 150. Feeder 200 may comprise any suitable hopper device known by those skilled in the art and preferably is configured to introduce macro clusters of particles into the process at a specified rate, which will depend on the rate of fiberization downstream. The nanoparticles may be introduced continuously at a specified rate, or an intervals at a specific rate. The macro clusters of nanoparticles in bundles may be broken apart prior to introducing them into feeder 200.

It should be recognized that the nanoparticles may be introduced into system 150 in many different forms. For example, raw nanoparticles may be produced as long separated fibers. In this form, the nanoparticles may be cut to obtain the desired length to diameter ratio.

System 150 further includes a separator 210, such as a blender or the like, for separating or breaking down the macro clusters/clumps of nanoparticles into smaller clusters/clumps of nanoparticles. Feeder 200 transfers nanoparticles into separator 210 by any mechanical means in a steady continuous state. The speed of transfer will depend on a variety of factors, such as the velocity of substrate 130 along feeder 120, the rate of fiberization of the nanoparticles and the like. With the help of controlling the amount of nanoparticles dropping into separator 210, the amount of nanoparticles dispersed into the substrate can be controlled to create a continuous manufacturing process.

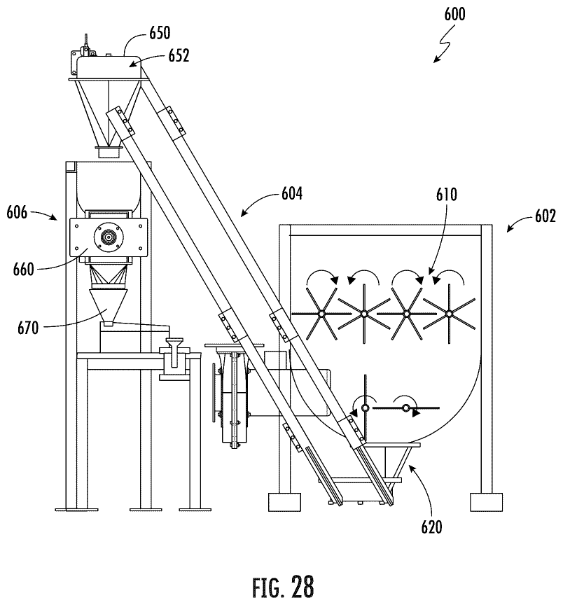

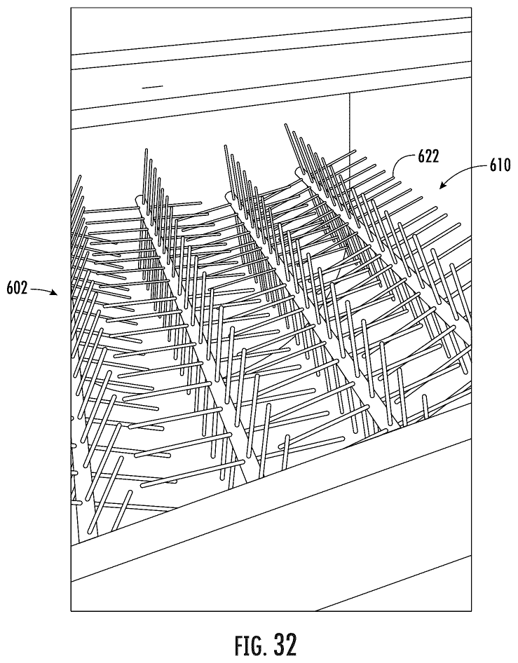

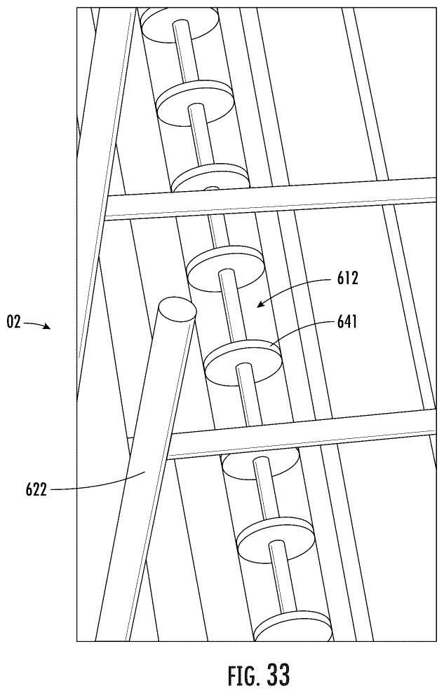

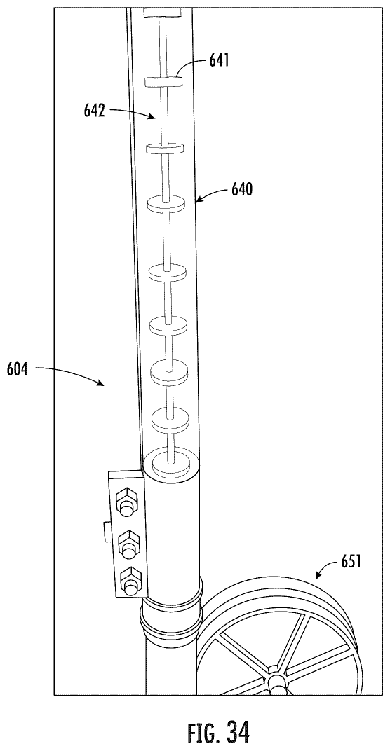

In one embodiment, separator 210 includes a housing 212 with a first opening 214 coupled to feeder 200 and a second opening 216 coupled to the downstream process. The second opening 216 is preferably sized to only allow clusters of nanoparticles having a certain size to pass therethrough. Separator 210 may include a plurality of rotatable blades (not shown) designed to rotate around a vertical axis within housing 212 to separate and open the coarse clusters of nanoparticles. The blades may have the same, or different, pitches and cambers to allow for sequential breaking down or “opening” of the entangled fibers as they pass from first opening 214 to second opening 216. One embodiment of a feeder 200 and separator 210 for a continuous manufacturing process is described below in FIGS. 28-34.

System 150 further includes a stream of gas that extends throughout the system from separator 210 to a nozzle 220 (discussed in more detail below). The stream of gas (along with a series of pumps as discussed below) provides the motive force to move the nanoparticles through system 150. In one embodiment, the stream of gas is created with an air compressor 230 configured to supply compressed air to the system, although it will be recognized that other forms of gas may be used to transfer the nanoparticles through system 150.

System 150 comprises one or more pumps for moving the clusters of nanoparticles and eventually the individual nanoparticles throughout the system. Pumps may comprise any suitable pump, such as positive-displacement, centrifugal, axial-flow and the like. In one embodiment, a first pump 240 includes a first inlet fluidly coupled to air compressor 230 by a first passage 242 and a second inlet fluid coupled to separator 210 by a second passage 244. Compressed air is drawn into first pump 240, which creates a negative pressure (e.g., a vacuum) to draw clusters of nanoparticles from separator 210 into pump (discussed in more detail below). System 150 may further include second and third pumps 250, 260 each fluidly coupled to the outlet of first pump 240. In a similar fashion, second and third pumps 250, 260 create negative pressures that draw the clusters of nanoparticles through a third passage 252.

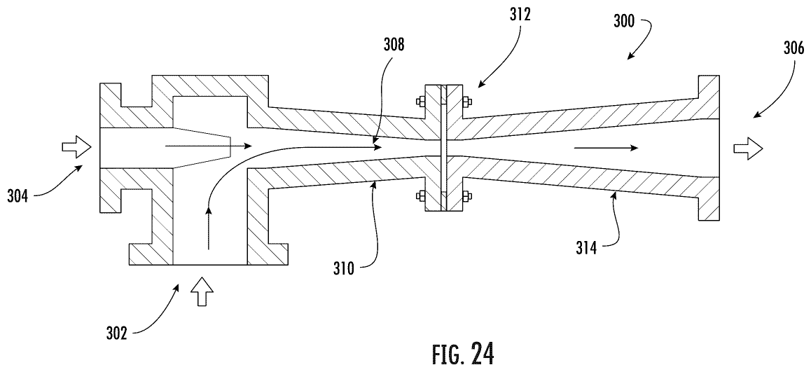

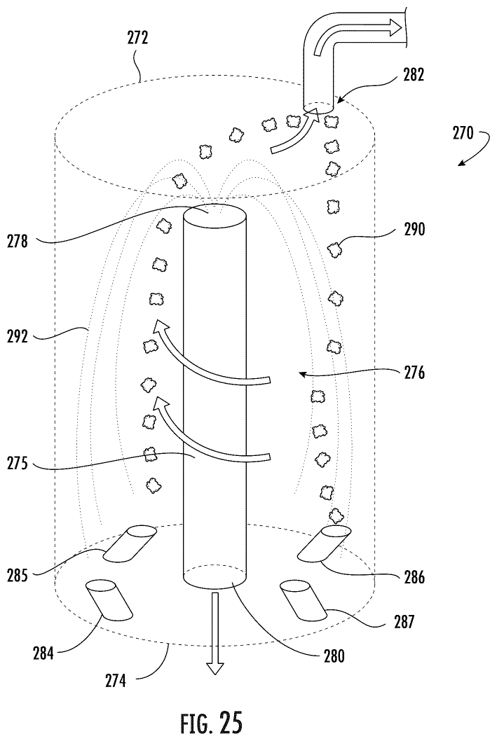

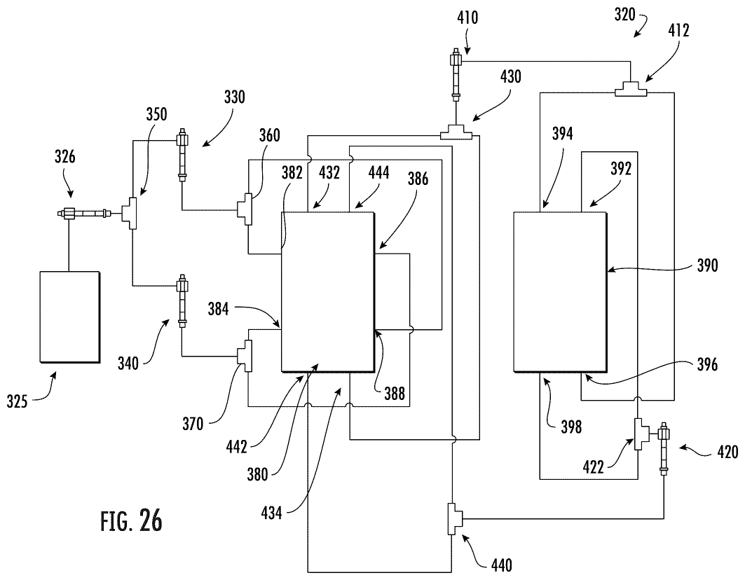

In certain embodiments, pumps 240 comprise eductors 300. As shown in FIG. 24, eductors 300 each comprise a motive fluid inlet 302 and a nanofiber inlet 304 coupled to an outlet 306 via a fluid passage 308. Fluid passage 308 includes a converging inlet nozzle 310, a diffuser throat 312 and a diverging outlet diffuser 314. High-pressure, low-velocity air is converted to low-pressure high-velocity air, thus producing the pressure difference required for suction. Based on the venturi effect and the Bernoulli principle, the primary fluid medium (e.g., compressed air) is used to create a vacuum to draw the nanoparticles into the eductor 300 and to expel them through outlet 306. The diameter of the eductor 300 depends on the volumetric flow rate of the compressed air, the suction requirement, the pressure drop, and the fluid pressure of the compressed air.

Referring back to FIG. 23, third passage 252 includes a junction 254 that splits third passage 252 into two separate passages, each leading to second and third pumps 250, 260. Junction 254 preferably includes a surface or wall that is disposed substantially perpendicular to third passage 252 to form a T-shaped intersection. The surface may by any surface that opposes the flow of the nanoparticles through the passage, such as the inner walls of the passage at a junction point, or other change in direction of the inner walls, e.g., a curved surface, a perpendicular surface or the like. Alternatively, the passage may include walls or other surfaces disposed within passage, or projecting into the passage in the fluid path. In one embodiment, the passage extends into a substantially T-shaped junction that includes two separate passages extending from the junction. The second eductor is configured to draw the nanoparticles into the T-shaped junction at a velocity sufficient to break apart at least some of the nanoparticles.

As the clusters of nanoparticles move through third passage 252, they are propelled against this surface or wall by the negative pressure applied by second and third pumps 250, 260. This velocity of the nanoparticles against junction 254 creates a collision with sufficient kinetic energy to cause at least some of the clusters of nanoparticles to break up into smaller clusters of nanoparticles and/or into individual nanoparticles having at least one dimension less than 1 micron.

In order to create the necessary kinetic energy to break down the clusters of nanoparticles, the air is propelled throughout system 150 at a velocity of about 500 feet/minute (fpm) to about 10,000 feet/minute, preferably about 2,000 fpm to about 6,000 fpm. The system 150 includes a sufficient amount of suction pressure, preferably at least about 20 psi. This suction pressure creates an overall pressure throughout the system of at least about 100 psi.

In certain embodiments, system 150 further includes fourth and fifth fluid passages 262, 264 that couple the outlets of second and third pumps 250, 260 with a reactor 270. As shown in FIG. 25, reactor 270 comprises a top surface 272, a bottom surface 274 and an internal annular chamber 276 extending from top surface 272 to bottom surface 274. Reactor 270 further includes a central tube 275 having an open upper inlet 278 and an outlet 280. Reactor 270 may further include one or more upper outlet(s) 282. Reactor 270 may be coupled to a source of energy (not shown) that is configured to create a vortex of swirling gas within annular chamber 276. The source of energy may comprise any suitable energy source, such as a pump, compressor, generator and the like. The swirling gas preferably flows around central tube 275 from the bottom of reactor 270 to the top to move the clusters of nanoparticles and the individual nanoparticles upwards from bottom surface 275 towards top surface 272.

In another embodiment, the vortex is created without a separate source of energy. In this embodiment, the clusters of nanoparticles 290 and individual nanoparticles 292 enter the reactor 270 through bottom inlets 284, 285, 286, 287. Inlets 284, 285, 286, 287 are angled upwards to facilitate movement of the nanoparticles and nanoparticles around central tube 275. In a preferred embodiment, at least one or more of the inlets 284, 285, 286, 287 is angled such that the nanoparticles and nanoparticles enter the reactor 270 such that they are substantially tangential to central tube 275. Once they have entered annular chamber 276, the velocity vector (speed and direction) of the nanoparticles and nanoparticles creates a vortex within reactor 270 that causes them to swirl around central tube 275 and upwards to the upper portion of chamber 276. The swirling gas preferably flows around central tube 275 from the bottom of reactor 270 to the top to move the clusters of nanoparticles and the individual nanoparticles upwards from bottom surface 275 towards top surface 272. Without any interruption, the nanoparticles 290 and nanoparticles 292 are blown from bottom of the reactor to the top. The vortex within chamber 276 may further break down (e.g., open up, separate and/or individualize) the clusters of nanoparticles 290 as they pass through reactor 270.

In some embodiments, reactor 270 may also be coupled to a source of energy (not shown) that is configured to create the vortex of swirling gas within annular chamber 276. The source of energy may comprise any suitable energy source, such as a pump, compressor, generator and the like.

The system 100 may further include another pump or source of negative pressure coupled to upper outlet 282. This negative pressure draws fibers through outlet 282 such that the fibers 290 exit the reactor 270. Since the individual nanoparticles 292 are significantly lighter than the entangled nanoparticles 290 that are still clustered together, these individual nanoparticles 292 are drawn into upper inlet 278 of central tube 275. Meanwhile, the larger and heavier clusters of nanoparticles 290 that have not yet been broken down are drawn through upper outlet 284. Upper outlet 284 may be coupled to other pumps (not shown), or to first pump 240. In this manner, the clusters of nanoparticles 290 are sent through the process again to become further broken down, creating a refeed system to further break down the remaining clusters of nanoparticles.

Outlet 280 of central tube 275 is coupled to nozzle 220 (see FIG. 23). The individual nanoparticles 292 are drawn into nozzle 220, where they are dispersed onto a surface of the substrate or into a fiber stream (discussed below). Nozzle 220 may comprise any suitable nozzle known by those in the art. In one embodiment, nozzle 220 has a plurality of outlets having an outer dimension tailored for the size (i.e., area) of the substrate passing below nozzle 220. The nozzle 220 will disperse the nanoparticles onto the substrate at a rate that is driven by the pressure throughout the system.

In certain embodiments, system 100 comprises more than one nozzle coupled to the outlet 280 of reactor 270. The nozzles may be arranged in any suitable form over the substrate, e.g., side-by side, in series, in parallel, or the like.

It will be recognized that pump 240, or pumps 250, 260 may directly feed the nanofiber/air mixture stream into the nozzle 220 (i.e., bypassing reactor 270). In this embodiment, the pressure within system is designed to create sufficient kinetic energy to break down or open up substantially all of the nanoparticles into individual nanoparticles such that reactor 270 is not required to separate the nanoparticles from the larger clusters of fibers.

Referring now to FIG. 26, another embodiment of a nanoparticle dispersal system 320 will now be described. As shown, system 320 includes a separator 325 for separating larger or macro clusters of nanoparticles into the smaller clusters of nanoparticles that will pass through system 320. A first eductor 326 is coupled to an outlet of separator 325 and serves to draw the nanoparticles from separator 325 and into system 320. An air compressor (not shown) is also coupled to eductor 326 to provide the motive fluid, as discussed above.

Similar to the previous embodiment, second and third eductors 330, 340 are coupled to an outlet of the first eductor 326. The nanoparticles are drawn through first eductor 320 and propelled against a surface of a T-shaped intersection 350 to break down at least some of the nanoparticles into smaller clusters or individual nanoparticles.

Each of the second and third eductors 330, 340 have outlets coupled to additional T-shaped intersections 360, 370. As before, nanoparticles are propelled against the surface of the T-shaped intersection 360, 370 to further break them down. The T-shaped intersections 360, 370 are each coupled to two fluid passages that enter the bottom portion 380 of a reactor. Thus, bottom portion 380 of reactor has four separate inlets 382, 384, 386, 388 for passage of the nanoparticles. Each of these inlets is preferably angled upwards and positioned in opposite corners of the reactor. This allows the nanoparticles to enter into the vortex of the reactor and then swirl upwards to an upper portion 390 of the reactor.

As discussed previously in reference to FIG. 25, the reactor includes an annular chamber with a central tube having an open upper end and a lower end coupled to a nozzle. The nanoparticles that have been sufficiently broken down into individual nanoparticles flow through this open upper end and into the central tube for dispersion through the nozzle. The heavier clusters of nanoparticles that have not yet been broken down exit the reactor through one of four separate outlets 392, 394, 396, 398. Eductors 410, 420 provide the motive force for drawing the nanoparticles from reactor 400, as discussed above. Outlets 392, 394 are each coupled to eductor 410 via a T-shaped intersection 412 and outlets 396, 398 are each coupled to eductor 420 via a T-shaped intersection 422. In this case, the nanoparticles flow from two passages into one passage as they pass through intersections 412, 422.

Eductors 410, 420 are each coupled to T-shaped intersections 430, 440. As described before, the nanoparticles are propelled into T-shaped intersections 430, 440 to further break them down into individual nanoparticles. T-shaped intersections 430, 440 are then each coupled to the bottom portion 380 of reactor 400 (via inlets 432, 434, 442, 444). This allows the nanoparticles to pass back into reactor 400 for further processing. This process continues for each cluster of nanoparticles until it has been entirely broken down into nanoparticles and passed through the central tube into the nozzle. As a last step, individualized nanoparticles are air sprayed from the nozzle onto any substrate or mixed with any fiber spinning stream. During this process, suction is up to 20 psi, pressure is up to 100 psi.

In certain embodiments, systems 150 or 200 may include a separate control system that monitors the nanoparticles to determine when they have been broken down into individual nanoparticles suitable for passing through nozzle. The control system may, for example, simple monitor the pressure throughout the system to ensure that sufficient pressure is being applied to the nanoparticles to break them down into nanoparticles. Alternatively, this control system may comprise a variety of different sensors disposed through the system to detect characteristics of the nanoparticles, such as weight or size. The sensors may be disposed, for example within reactor 400 such that the control system may control various parameters of reactor 400, such as the negative pressure applied to outlets, 392, 394, 396, 398, the speed of the vortex passing around the annular chamber, or the pressure applied to central tube that draws then nanoparticles into the nozzle.

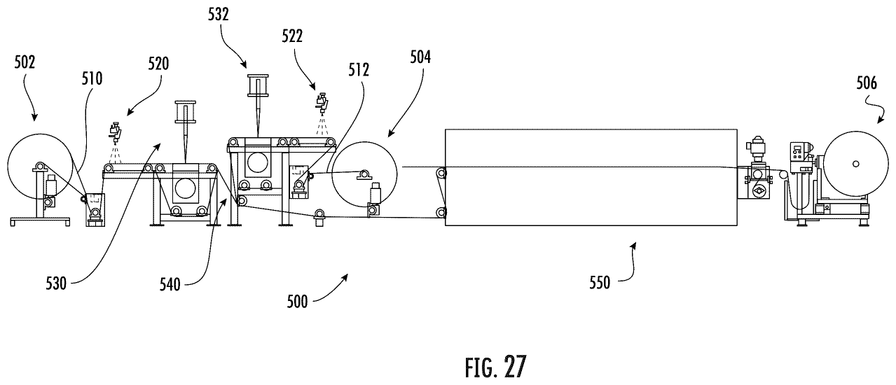

FIG. 27 illustrates another embodiment of a system 500 for manufacturing multiple layers of filter media. As shown, system 500 comprises first and second unwinders 502, 504 and a single winder 506 for winding first and second substrates 510, 512 downstream through system 500. As in previous embodiments, system 500 may further comprise a support surface (not shown) for each of the substrates 510, 512. First and second unwinders 502, 504 serve to advance the first and second substrates 510, 512 into the process, where they are joined together and then wound towards a single winder 506, as discussed below.

System 500 includes first and second spray coaters 520, 522, each positioned downstream of first and second unwinders 502, 504 for applying binding agents to the first and second substrates 510, 512. System 500 further includes first and second fiberization systems/devices 530, 532 positioned downstream of each of the spray guns 520, 522. As discussed previously, fiberization devices 530, 532 generate individual nanoparticles and disperse those nanoparticles onto substrates 510, 512.

Once the nanoparticles have been dispersed into substrates 510, 512, the two substrates are joined together at a junction point 540 such that they are advanced downstream together. The two substrates may be bonded to each other at this point, or they may simply be laid one on top of the other.

The system 500 further includes a heater/drying device, such as an IR oven 550, downstream of the junction point 540 of the two substrates. The heating/drying device heats and dries the two substrates to bond them to each other and to bond the nanoparticles to the fibers within the substrates. The substrates may, for example, be laminated to each other.

In certain embodiments, nanoparticles are dispersed into both of the substrates 510, 512. In one such embodiment, system 500 is designed such that nanoparticles are dispersed through first surfaces of each of the substrates. The substrates can then be joined such that the first surfaces are facing each other. Alternatively, the first surfaces may be facing away from each other (i.e., joining the substrates at the second, opposing surfaces of each substrate). In yet another embodiment, a first surface of the first substrate is joined to a second surface of the second substrate.

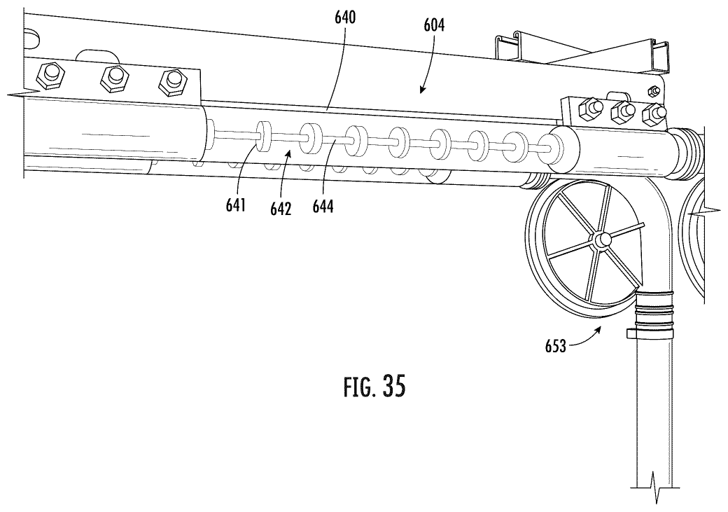

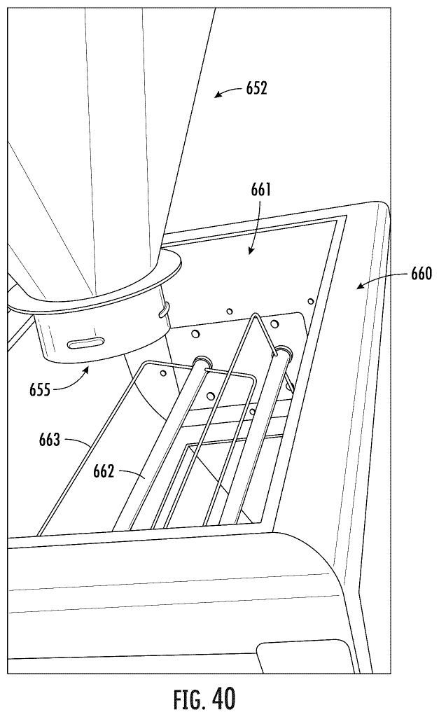

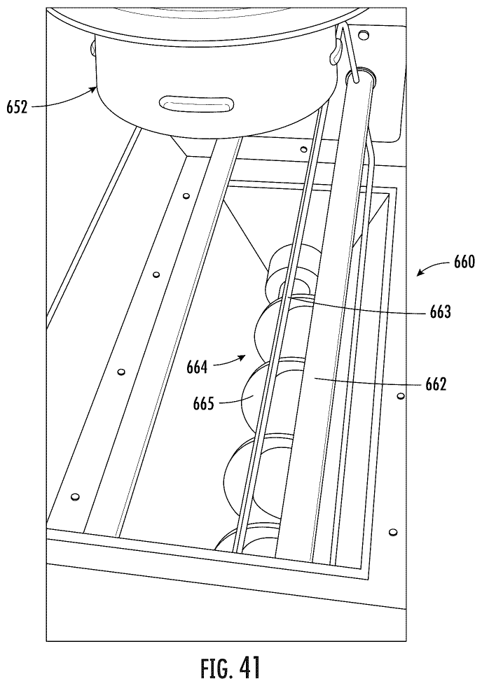

FIGS. 28-44 illustrate one embodiment of a feed system 600 for separating or breaking down larger clusters/clumps of nanoparticles into smaller clusters and/or into individual nanoparticles and then conveying those smaller clusters and/or individual nanoparticles into one of the filter manufacturing systems described above. Feed system 600 is particularly useful for introducing nanoparticles into a continuous manufacturing process at a controlled mass or volumetric flow rate (i.e., the quantity, volume or total mass of nanoparticles that pass through feed system 600 per unit of time). The nanoparticles may be introduced continuously at a specified flow rate, or an intervals at a specific flow rate. The speed of transfer will depend on a variety of factors, such as the velocity of substrate 130 along feeder 120 (see FIG. 22), the rate of fiberization of the nanoparticles, the desired amount of nanoparticles dispersed into a given area/volume of substrate and the like. With the help of controlling the amount, mass or volume of nanoparticles dropping into the manufacturing system, the amount of nanoparticles dispersed into the substrate can be controlled to create a continuous manufacturing process with improved quality and yield and reduced cost and time. In addition, the system is scalable and produces filter media with less variation.

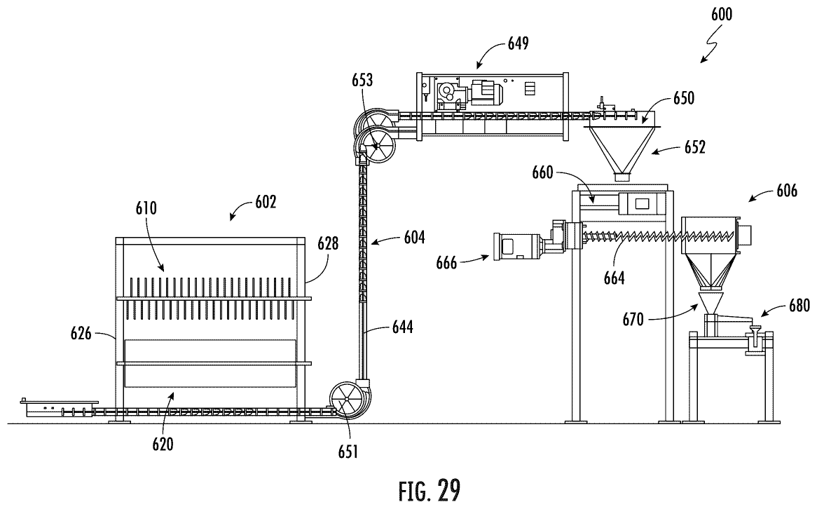

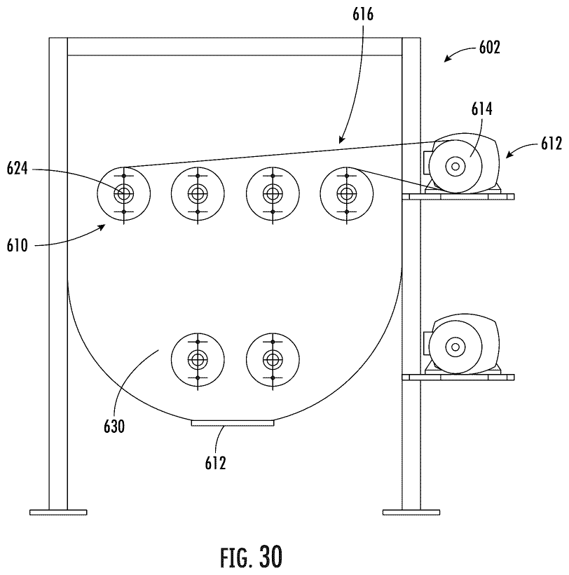

As shown in FIGS. 28 and 29, feed system 600 generally comprises a container or bulk bin 602, such a hopper, for receiving relatively large (i.e., macro) clusters or bundles of nanoparticles and an elevator 604 for elevating the nanoparticles to a dispersal system 606 that disperses the nanoparticles into the filter manufacturing system (discussed above). The macro clusters or bundles of nanoparticles may be partially broken apart prior to introducing them into bulk bin 602, and/or they may be partially or completely broken up and separated within container 602. It should be recognized that the nanoparticles may be introduced into feed system 600 in many different forms. For example, raw nanoparticles may be produced as long separated fibers, such as nanofibers, mini-fibers or the like. In this form, the nanoparticles may be cut to obtain the desired length to diameter ratio.

Bulk bin 602 functions as a separator, such as a blender or the like, for separating or breaking down the macro clusters or bundles of nanoparticles into smaller clusters or masses of nanoparticles or directly into individual nanoparticles. In one embodiment, bulk bin 602 includes a plurality of rotatable screws or rotors 610 designed to rotate around an axis within bulk bin 602 to separate and open the coarse clusters of nanoparticles (see FIGS. 30-33 discussed in more detail below).

As shown in FIGS. 30-32, rotors 610 may also function to drive the individual nanoparticles downwards towards an opening 612 at or near the bottom surface of container 602. The individual nanoparticles do not behave in the same manner as macro sized objects. Because the mass of nanoscale objects is so small, the force of gravity has very little effect on the attraction between objects of this size. Thus, gravitational forces may have little to no effect on these particles (i.e., they are not automatically pulled downwards towards opening 612 by gravity). Opening 612 is coupled to a collection vessel 620 (see FIG. 29) for collecting the individual nanoparticles that have been broken up in container 602 and feeding them to elevator 604 (discussed in more detail below).

As shown in FIG. 30, rotors 610 may be driven by an external motor 612. In one embodiment, motor 612 includes a rotatable drive shaft 614 coupled to a cable or pully system 616. Each of the rotors 610 may be formed on a rotatable disc or shaft 618 that is coupled to the pulley system 616 such that rotation of drive shaft 614 causes rotation of the rotors 610. In certain embodiments, a single motor 612 will drive all of the rotors 610. In other embodiments, the system may include multiple motors, with each motor independently driving one or more of the rotors 610. Motor 612 may comprise any suitable motor, such as a brushless DC motor, permanent magnetic DC motor, stepper motor, linear motor, synchronous motor, electromagnetic induction motor, servomotor, PMDC brush motor, shunt motor, series motor, compound motor or the like.

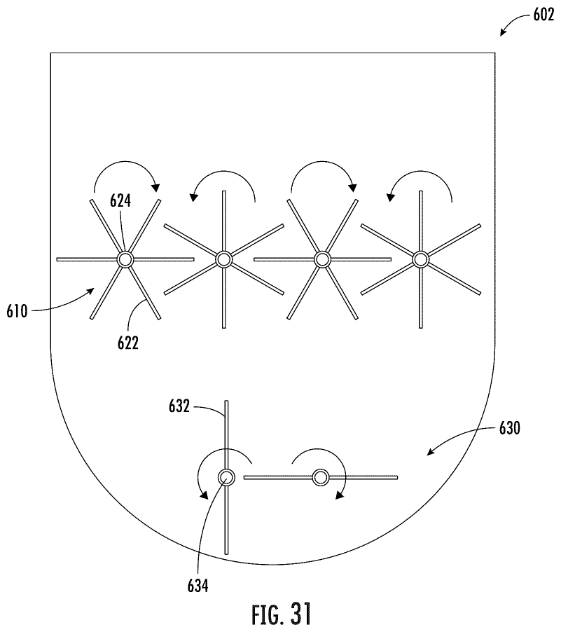

As shown in FIG. 31, rotors 610 each include a plurality of individual blades 622 spaced circumferentially around a central hub 624. In one such embodiment, each hub 624 includes five separate blades 622 spaced uniformly around the hub, although it will be recognized that the blades may include less than 5 individual blades or more than 5 individual blades. Blades 622 may have the same, or different, pitches and cambers to allow for sequential breaking down or “opening” of the entangled fibers as they pass through bulk bin 602.

In an exemplary embodiment, each central hub 624 is positioned such that its blades 622 rotate about an axis transverse to a vertical axis extending through bulk bin 602. In an exemplary embodiment, this axis is substantially perpendicular to the vertical axis of bulk bin 602. Thus, as the clusters of nanoparticles pass downwards through bulk bin 602, blades 622 engage these clusters to separate them or break them down into smaller clusters/clumps of nanoparticles or directly into individual nanoparticles. Blades 622 also function to force or convey the nanoparticles downwards through the bulk bin 602. Bulk bin 602 may include a single row of rotors 610 or multiple rows of rotors 610.

Rotors 610 may be configured to rotate in opposite directions, with some of the hubs 624 rotating counterclockwise and others rotating clockwise. Alternatively, all of the rotors 610 may rotate in the same direction, i.e., counterclockwise or clockwise. In an exemplary embodiment, container 602 includes a row of at least four rotors 610 extending substantially parallel to each other across a horizontal axis of the container 602, with each alternate propeller rotating in an opposite direction from the adjacent propeller, as shown in FIG. 31.

Each central hub 624 of rotors 610 preferably extends from one side 626 of bulk bin 602 to the other side 628 and includes multiple sets of blades 622 extending along its entire length. Each hub 624 may include 2 or more, 5 or more, 10 or more, 20 or more, or 40 or more sets of blades extending along its length depending on the overall dimensions of bulk bin 602. Each set of blades are preferably spaced from each other by a suitable distance that ensures that larger clumps of nanoparticles cannot fall between the sets of blades without contacting the blades.

In certain embodiments, the hubs 624 are staggered (vertically and/or horizontally) from each other along the width and/or depth of bulk bin 602 such that each set of blades 622 covers a different cross-sectional area of the interior of bulk bin 602. In addition, the blades 622 may be designed to overlap with each other such that one set of blades on one hub extends through the gap between two sets of blades of another hub 624. This ensures that clumps of nanoparticles residing between two sets of blades are contacting by the blades of a different hub.

In one embodiment, container 602 includes a lower row of rotors 630 that primarily function to sweep the nanoparticles from the internal walls of bulk bin 602 to drive them into opening 612. To that end, rotors 630 preferably comprise at least two rotating blades 632 around a central hub 634. Hubs 634 preferably rotate in opposite directions, with one hub rotating clockwise and the other hub rotating counterclockwise such that the rotors 630 may sweep nanoparticles clinging to either side of container 602. Hubs 634 preferably extend along an axis substantially perpendicular to the vertical axis of container 602, although it will be recognized that other embodiments have been considered. For example, bulk bin 602 may include a plurality of rotors 630 positioned along the internal walls of bulk bin 602 to sweep nanoparticles from these walls and drive them towards opening 612.

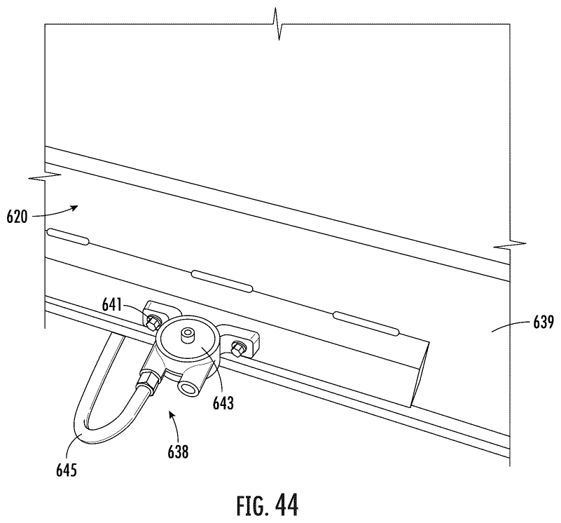

As shown in FIG. 28, collection vessel 620 has an upper opening coupled to bulk bin 602 and a lower opening coupled to elevator 604. The lower opening has a substantially smaller cross-sectional area than the upper opening such that the nanoparticles are “funneled” downwards to control the flow rate of the nanoparticles through the system, as discussed in more detail below. In addition, vessel 620 includes one or more mechanisms for conveying or driving the nanoparticles therethrough. In one embodiment, at least one of these mechanisms includes one or more vibration elements 638 (see FIG. 44) coupled to vessel 620 that function to convey the nanoparticles through vessel 620 and into elevator 604. The vibration elements also function to pulse the nanoparticles to break apart those nanoparticles that tend to stick in clumps within vessel 620. This allows the nanoparticles to free themselves from these clumps and fall into elevator 604.

The vibration elements may have an amplitude of about 5 pounds-force to about 500 pounds-force, preferably about 75 pounds-force to about 250 pounds-force, and may oscillate at a frequency of about 2,000 Hz to about 15,000 Hz, preferably about 7,000 Hz to about 11,000 Hz. The vibration elements may be located on the walls and/or the interior of vessel 620. The vibration elements may be powered by any suitable means. In one embodiment, the vibration elements comprise electromechanical devices that are powered by a DC electrical supply. The vibration element converts the electric current into pulses. In another embodiment, the vibration elements are pneumatically driven by compressed air.

Vibration elements 638 may be coupled to one or more of the outer walls 639 of collection vessel 620 (or any of the other vessels within feed system 600). In one embodiment, vibration elements 638 each comprise one or more attachment elements 641 for attaching an oscillator 643 to outer walls 639 and a connection element 645 for coupling vibration element 638 to a suitable power source. Vibration elements 638 are configured to vibrate the outer walls 639 of collection vessel to pulse the nanoparticles and break apart those nanoparticles that tend to stick in clumps within vessel 620. This allows the nanoparticles to free themselves from these clumps and fall into elevator 204.

Referring now to FIGS. 28, and 33-35, elevator 604 functions to elevate the nanoparticles exiting vessel 620 from a first height to a second height greater than the first height. Nanoparticles generally do not convey because they have little to no weight. As a consequence, the nanoparticles tend to compact against themselves, sticking together in clumps that form over any type of opening. Elevator 604 overcomes these issues by both conveying and elevating the nanoparticles from vessel 620 to dispersal system 606.

In certain embodiments, elevator 604 comprises one or more transport tube(s) 640 that function to convey the nanoparticles to a higher elevation without compressing them back into clumps. In certain embodiments, tube 640 includes at least one section that extends at a transverse angle to the vertical (see FIG. 28). In other embodiments, tube 640 includes at least one section that is substantially parallel to vertical (see FIG. 29). Elevator 604 comprises a plurality of discs 641 that are spaced from each other throughout tube 640. Discs 641 generally have a diameter sized to allow discs 641 to pass through tube 640 (i.e., slightly less than the inner diameter of tube 640). In addition, the diameter of discs 641 are close enough to the inner diameter of tube 640 to define interior compartments 642 between adjacent discs 641. The discs 641 function to isolate the interior of the compartments 642 as each compartment 642 is conveyed through tube 640.

Tube 640 extends from a lower opening (not shown) in collection vessel 620 to an upper opening 650 of a funnel-shaped conveyance vessel 652 in dispersal device 606. For reasons discussed below, vessel 652 is located above vessel 620 and, therefore, tubes 640 convey and elevate the nanoparticles from a first height to a second height greater than the first height.

Elevator 604 further includes a cable 644 within tube 640 that conveys the compartments 642 through the tube 640. In one embodiment, cable 644 extends through each disc 641 within tube 640 and is coupled to a suitable source of energy for moving cable 644 (and discs 641 therewith) through the tube. Tube 640 may extend upwards from vessel 620 to dispersal device 606 and then back downwards to vessel 620 (see FIG. 28). The compartments 642 moving upwards generally contain the nanoparticles and the compartments 642 moving downwards are substantially empty of nanoparticles. Alternatively, tube 640 may be a continuous tube that moves in one direction.

Referring again to FIG. 29, elevator 604 preferably comprises a motor 649 coupled to cable 644 for propelling cable 644 in one direction through feed system 600 such that discs 641 are propelled in that direction. Motor 649 may comprise any suitable motor, such as a brushless DC motor, permanent magnetic DC motor, stepper motor, linear motor, synchronous motor, electromagnetic induction motor, servomotor, PMDC brush motor, shunt motor, series motor, compound motor or the like.

Cable 644 may be coupled to one or more drive wheels that redirect cable 644 through feed system 600. For example, as shown in FIG. 29, cable 644 preferably extends substantially horizontally underneath bulk bin 602 and then is redirected into a vertical direction by a first drive wheel 651 to elevate the clumps of nanoparticles. A second drive wheel 653 functions to redirect the cable 604 to a substantially horizontal direction where it passes over vessel 652 to distribute the nanoparticles into dispersal system 606.

Tube 640 comprises one or more openings (not shown) that are aligned with the openings in vessel 620 and vessel 652 to allow the nanoparticles to enter compartments 642 from vessel 620 and to exit compartments 642 into vessel 652. In certain embodiments, the opening(s) located adjacent vessel 620 are on an upper surface of tube 640 and the opening(s) located adjacent vessel 652 are on a lower surface of tube 640. Alternatively, tube 640 may have rotatable sections that allow the openings to move from one configuration to another. Thus, as an individual compartment 642 passes by the opening underlying vessel 620, nanoparticles may fall into compartment 642 from vessel 620. As the compartment 642 continues to move upwards along tubes 642, the inner walls of tubes 642 and the discs 641 of compartments 642 will enclose the interior of compartment 642 such that the nanoparticles are trapped therein. This allows the nanoparticles to be conveyed along tubes without compressing them into bundles or clumps.

Alternatively, the openings in the tube 640 may be capable of opening and closing. For example, elevator 604 may include one or more actuators that function to open and close these openings in tubes 640. The actuators may comprise any suitable mechanisms, such as electronic actuators, pneumatic actuators, mechanical actuators or the like. In certain embodiments, system 600 further includes a controller (not shown) that functions to automatically open and close these openings at the appropriate times, or based on data obtained from sensors (i.e., opening when they pass underneath vessel 620 and then closing them as they move upwards towards dispersal device 606). In other embodiments, system 600 may mechanical elements that cooperate with each other to automatically open and/or close the openings at they pass by vessel 620 and dispersal device 606.

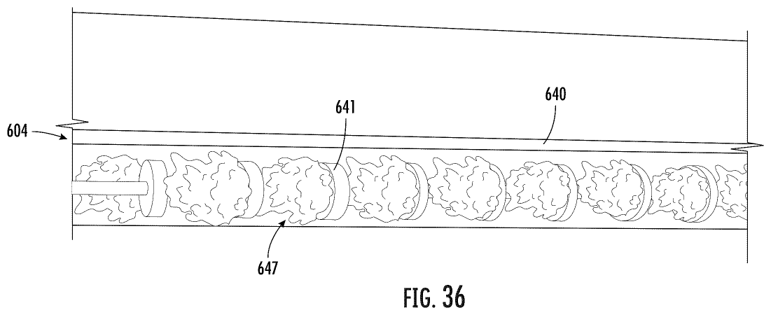

FIG. 36 illustrates clusters of nanoparticles 647 being moved by elevator 604. As shown, each clump of nanoparticles 647 resides within the compartment 642 between two discs 641 within tubes 640 of elevator 604. As the discs 641 are propelled through tube 640, the clumps of nanoparticles 647 are propelled therewith.

Referring back to FIG. 29, dispersal system 606 functions to control the speed of conveyance or flow rate of nanoparticles passing into the filter media manufacturing system. In particular, dispersal system 606 ensures that an appropriate amount of nanoparticles are dispersed onto the fibers within the substrate. For example, dispersal system 606 is configured to convey the nanoparticles at a specified mass or volumetric flow rate that is substantially consistent with the rate that the feeder 200 advances the substrate from the upstream end to the downstream end. This ensures that a substantially constant quantity of nanoparticles is dispersed into each portion or subsection of the substrate, allowing the system to manufacture relatively uniform filter medias with less variation from one filter media to the next. The specific rate of dispersion of nanoparticles into the substrate will depend on the desired specifications of the final filter product, such as the preferred mass of nanoparticles dispersed within a volume or square area of filter media. In an exemplary embodiment, the nanoparticles are dispersed into the moving substrate at a rate of about 0.1 grams/m² to about 10 grams/m² although it will be understood that this rate may vary depending on the specifications of the final product.

The rate of advancement of the substrate will depend on many factors in the production process, including the desired amount of nanoparticles dispersed into each section of the substrate. In one embodiment, the rate of advancement of the substrate is about 0.05 to about 1 meters/second.

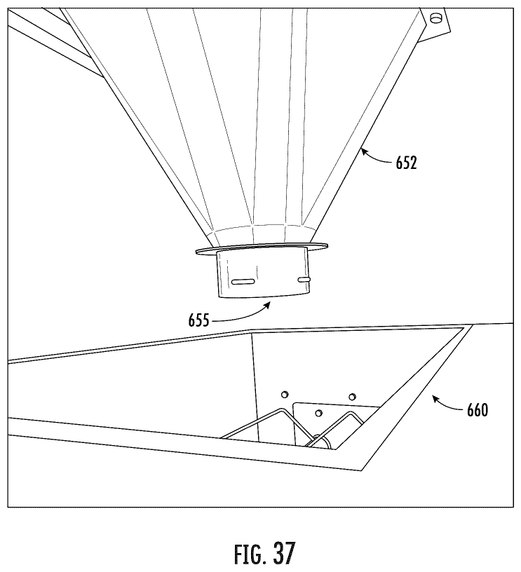

Dispersal system 606 generally comprises an upper funnel-shaped vessel 652 that collects the nanoparticles from conveyer 604, a feed bin 660 and one or more lower funnel-shaped vessels 670. As shown in FIGS. 29 and 37, upper funnel-shaped vessel 652 has an upper opening 650 coupled to the opening in tube 640 of elevator 604 and a lower opening 655 coupled to feed bin 660. The lower opening 655 has a substantially smaller cross-sectional area than the upper opening 653 such that the nanoparticles are “funneled” downwards to control the flow rate of the nanoparticles through the system. Similar to collection vessel 620, vessel 652 may also include one or more vibration elements that pulse the nanoparticles and inhibit them from forming into clumps. These vibration elements may, for example, be located on the outer walls of vessel 652. Alternatively, the vibration elements may be positioned within vessel 652 to facilitate the conveyance of the nanoparticles through vessel 652.

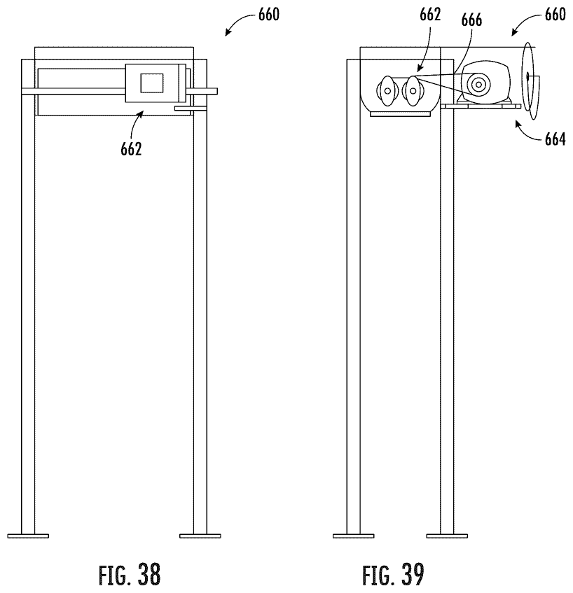

Referring now to FIGS. 38 and 39, feed bin 660 comprises a first opening 661 for receiving the nanoparticles from vessel 652 and a second opening (not shown) for conveying the nanoparticles to lower vessel 670. Feed bin 660 further includes one or more mechanisms within the interior of feed bin 660 to convey the nanoparticles therethrough. Feed bin 660 preferably includes one or more rotating cylinders 662 extending through the interior of feed bin 660. One or more rods 663 are coupled to cylinders 662 and configured to rotate therewith to sweep the nanoparticles downward through feed bin.

Feed bin further includes an auger 664 that functions to move the nanoparticles in a generally horizontal direction through feed bin 660 to lower vessel 670. In a preferred embodiment, auger 664 includes a plurality of curved blades 665 that function to receive clusters of nanoparticles that have fallen vertically into feed bin 660 and to redirect these nanoparticles in a horizontal direction through feed bin 660. Curve blades 665 also function to control the volumetric flow rate of the nanoparticles through the feed bin 660 and into the filter manufacturing system. Auger 664 may be driven by any suitable motor 666, such as any of those described above.

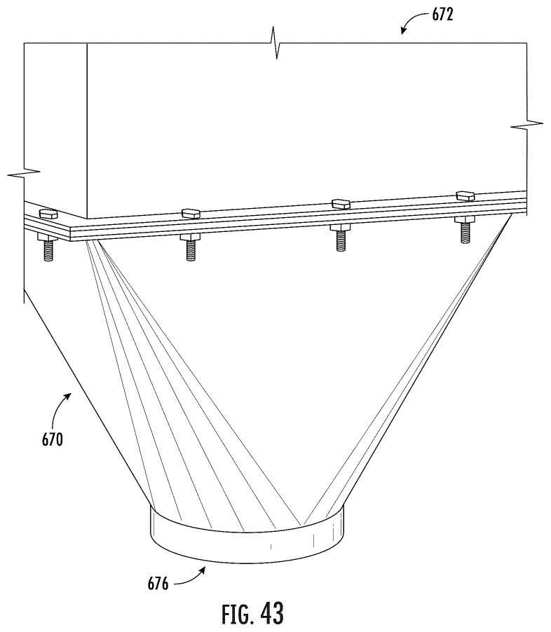

Referring now to FIG. 43, lower vessel 670 has an upper opening 672 coupled to an opening in feed bin 660 and a lower opening 676 coupled to the fiber manufacturing system described above. Lower vessel 670 preferably has a substantially funnel shape such that the lower opening has a smaller cross-sectional area than the upper opening to control the flow rate of nanoparticles passing therethrough. Similar to collection vessel 620, lower vessel 670 may include one or more vibration elements that pulse the nanoparticles and inhibit them from forming into clumps. These vibration elements may, for example, be located within the internal walls of vessel 670. Alternatively, the vibration elements may be positioned to facilitate the conveyance of the nanoparticles through vessel 670.

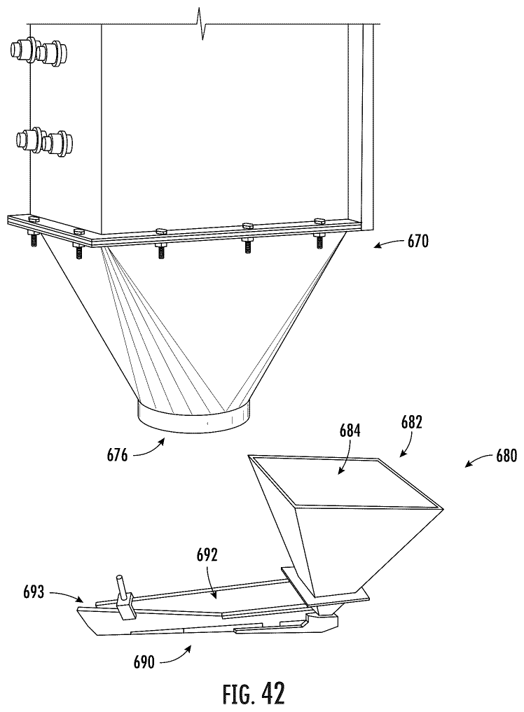

Referring now to FIG. 42, feed system 600 may further include a fine-tuned flow control device 680 that receives nanoparticles from vessel 670 and provides a final control of the volumetric flow rate of the nanoparticles into the filter manufacturing apparatus. Flow control device 680 includes a funnel-shaped vessel 682 with an opening 684 for receiving the nanoparticles from vessel 670 and a lower opening (not shown) coupled to a feeder tray 690. Feeder tray 690 includes a feed channel 692 that tapers towards an opening 693. Opening 693 may be coupled to any suitable filter media manufacturing apparatus, such as any of those discussed above, or others that may be contemplated by those of skill in the art.

### Example 1

Synthetic nanoparticles (mini fibers (0.5 micron in diameter and 100 micron in length) were dispersed onto a wet laid and calendared fiber substrate (labeled Nano in TABLE 1) with the system and methods described above. The substrate and the nanoparticles were then calendared. during calendaring, the mini fibers were thermally bonded to the fibers within the substrate at a temperature of 243 degrees Fahrenheit for 3 seconds, 4 seconds and 5 seconds (labeled 243F, 3 sec., 4 sec. and 5 sec. respectively in Table 1). FIGS. 46A-46C are microscopic images of high density polyethylene (HDPE) nanoparticles that were dispersed onto a substrate comprising a carded media of fibers as described herein.

Fiber substrates (wet laid and calendared) were also produced without dispersing nanoparticles therein as a control (labeled No Nano in TABLE 1). The first No Nano sample was tested “as-is” without heating or calendaring the substrate. The second No Nano sample was tested after heating and calendaring or pressing the substrate at 243 degrees Fahrenheit. Applicant also compared the specifications for a meltblown equivalent grade substrate (without nanoparticles) to a number of meltblown fiber substrates that included nanoparticles therein (labeled Meltblown Equivalent). Applicant measured the mean and maximum flow pore sizes in microns and the bubble point in (in/h20). As discussed above, the bubble point (pressure) is the amount of force required to pass liquid through the substrate (i.e., the higher the number, the more difficult it is to pass the liquid therethrough). The results of this testing are shown below in TABLE 1.

TABLE 1

| | Meltblown | No Nano | No Nano | Nano | Nano | Nano |
|---|---|---|---|---|---|---|
| | Equivalent | “As Is” | 243f Pressed | 243f 3 sec | 243f 4 sec | 243f 5 sec |
| Mean Flow | 3.3 | 27.4 | 24.36 | 6.71 | 3.88 | 3.40 |
| Pore | | | | | | |
| Max Pore | NA | 41.76 | 36.65 | 34.63 | 21.32 | 15.8 |
| Bubble | 28 | 5.53 | 6.3 | 6.672 | 10.83 | 14.54 |
| Point | | | | | | |

As shown in the above table, heating and pressing the No Nano sample had a marginal impact on the maximum and mean flow pore sizes, reducing them from 41.76 microns to 36.65 microns and from 27.4 microns to 24.36 microns, respectively, the mean and maximum flow pore sizes for the substrates incorporating nanoparticles were significantly less than the mean and maximum flow pore sizes for No Nano samples. In particular, the mean flow pore sizes of the substrates incorporating nanoparticles were at least 75% less than the mean flow pore sizes of the substrates without nanoparticles, i.e., mean flow pore sizes of 6.71 microns, 3.88 microns and 3.4 microns. This latter substrate had a mean flow pore size substantially equal to the meltblown equivalent specifications (3.4 microns compared to 3.3 microns). This demonstrates that the systems and methods described herein provide filter media with substantially reduced mean flow pore sizes, which increases the efficiency of the filter in capturing contaminants

The maximum flow pore sizes were also reduced with the nanoparticles. As shown above, the maximum flow pore sizes of the substrates incorporating nanoparticles were 34.68 microns, 21.32 microns and 15.8 microns. In particular, the maximum flow pore size of the substrate that was thermally bonded for 5 seconds was less than half the maximum flow pore size of the No Nano substrate even after the heating step was duplicated with this sample.

In addition, the bubble point (pressure) for the substrates that incorporated nanoparticles was substantially less than the bubble point for the meltblown equivalent substrate (without nanoparticles). The bubble point with nanoparticles was at least 50% less than the bubble point without nanoparticles. In some cases, the bubble point with nanoparticles was 67% less than the bubble point without nanoparticles. This demonstrates that the systems and methods described herein provide filter media with substantially reduced bubble points, which increases the throughput of the liquid passing through the filter.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment comprises a substrate comprising one or more fibers and having a first surface and an opposing second surface, and a plurality of nanoparticles disposed within the substrate at least between the first and second surfaces. At least some of the nanoparticles are bonded to at least some of the fibers within the substrate.

A second embodiment is the first embodiment, wherein at least some of the nanoparticles are thermally bonded to at least some of the fibers.

A 3^{rd} embodiment is any combination of the first 2 embodiments, further comprising a binding agent within the substrate retaining at least some of the nanoparticles to at least some of the fibers.

A 4^{th} embodiment is any combination of the first 3 embodiments, wherein the binding agent comprises a non-soluble adhesive.

A 5^{th} embodiment is any combination of the first 4 embodiments, wherein the nanoparticles have at least one dimension less than about 20 microns.

A 6^{th} embodiment is any combination of the first 5 embodiments, wherein the nanoparticles have at least one dimension less than about 1 micron.

A 7^{th} embodiment is any combination of the first 6 embodiments, wherein the nanoparticles comprise mini fibers having at least one dimension between about 1 micron and about 20 microns.

An 8^{th} embodiment is any combination of the first 7 embodiments, wherein the mini fibers have at least one dimension of about 5 microns.

A 9^{th} embodiment is any combination of the first 8 embodiments, wherein the mini fibers have a length of about 100 microns to about 600 microns.

A 10^{th} embodiment is any combination of the first 9 embodiments, wherein the mini fibers are selected from a group consisting of metallic fibers, carbon fibers, polypropylene (PP), nylon fibers, polybutylene (PBT), ethylene polyester (PET), polylactic acid (PLA), polyamide (PA), glass, biosoluble glass, ceramic materials, acrylic, polyethylene, high density polyethylene (HDPE) low density polyethylene (LDPE) and combinations thereof.

An 11^{th} embodiment is any combination of the first 10 embodiments, wherein the substrate comprises a porous membrane.

A 12^{th} embodiment is any combination of the first 11 embodiments, wherein the filter media has a mean flow pore size of less than about 10 microns.

A 13^{th} embodiment is any combination of the first 12 embodiments, wherein the mean flow pore size is less than about 4 microns.

A 14^{th} embodiment is any combination of the first 13 embodiments, wherein the filter media has a bubble point of less than about 20 in/h20.

A 15^{th} embodiment is any combination of the first 14 embodiments, wherein the bubble point is less than about 15 in/h20.

A 16^{th} embodiment is any combination of the first 15 embodiments, wherein the fibers comprise biocomponent fibers.

A 17^{th} embodiment is any combination of the first 16 embodiments, wherein the fibers in the substrate are bonded together by thermal bonding, ultrasonically bonding, cellulose wet laid, glass wet laid, synthetic wet laid, composite wet laid, needle punching, meltblown, air laid, spunbond and combinations thereof.

An 18^{th} embodiment is any combination of the first 17 embodiments, wherein the fibers are hydroentangled.

A 18^{th} embodiment is any combination of the first 18 embodiments, wherein the fiber substrate comprises polyolefins, polyester, polyethylene (PE), polypropylene (PP), blends of PP and PE, PBT, PET, CoPET, PLA, PA, PHB, PVOH, polyamide and combinations thereof.

A 20^{th} embodiment is any combination of the first 19 embodiments, wherein an area density of the nanoparticles decreases from the first surface to the second surface.

A 21^{st} embodiment is any combination of the first 20 embodiments, wherein the fiber substrate has a thickness from a first surface to a second surface, wherein the nanoparticles are disposed within the substrate in at least 25% of the thickness from the first surface to the second surface.

An 22^{nd} embodiment is any combination of the first 21 embodiments, wherein the nanoparticles are disposed within the fiber substrate in at least 50% of the thickness from the first surface to the second surface.

A 23^{rd} embodiment is any combination of the first 22 embodiments, wherein the nanoparticles are generated within a gas and dispersed through a first surface of the fiber substrate.

A 24^{th} embodiment is any combination of the first 23 embodiments, wherein the nanoparticles are disposed within the fiber substrate from the first surface to the second surface.

A 25^{th} embodiment is any combination of the first 24 embodiments, wherein an area density of the nanoparticles at a midpoint between the first surface and the second surface is about 25% of an area density of the nanoparticles at the first surface.

A 26^{th} embodiment is any combination of the first 25 embodiments, wherein the area density of the nanoparticles at the second surface is about 50% of the area density of the nanoparticles at the first surface.

In another aspect, a liquid filter is provided comprising any combination of the first 26 embodiments.

In another aspect, a first embodiment is provided comprising a housing comprising an inlet for receiving a liquid and an outlet for discharging the liquid and a filter media disposed within the housing between the inlet and the outlet. The filter media comprises one or more fibers and having a first surface and an opposing second surface and a plurality of nanoparticles disposed within the filter media at least between the first and second surfaces. At least some of the nanoparticles are bonded to at least some of the fibers within the filter media.

A second embodiment is the first embodiment, wherein the filter media has a mean flow pore size of less than about 10 microns.

A 3^{rd} embodiment is any combination of the first 2 embodiments, wherein the mean flow pore size is less than about 4 microns.

A 4^{th} embodiment is any combination of the first 3 embodiments, wherein a ratio of a maximum flow pore size to the mean flow pore size is less than about 10.

A 5^{th} embodiment is any combination of the first 5 embodiments, wherein the ratio is less than about 6.

A 6^{th} embodiment is any combination of the first 5 embodiments, wherein the filter media has a bubble point of less than about 20 in/h20.

A 7^{th} embodiment is any combination of the first 6 embodiments, wherein the bubble point is less than about 15 in/h20.

An 8^{th} embodiment is any combination of the first 7 embodiments, wherein the filter media further comprises a support layer.

A 9^{th} embodiment is any combination of the first 8 embodiments, wherein at least some of the nanoparticles are thermally bonded to at least some of the fibers.

A 10^{th} embodiment is any combination of the first 9 embodiments, further comprising a binding agent within the substrate retaining at least some of the nanoparticles to at least some of the fibers.

An 11^{th} embodiment is any combination of the first 10 embodiments, wherein the binding agent comprises a non-soluble adhesive.

A 12^{th} embodiment is any combination of the first 11 embodiments, wherein the nanoparticles have at least one dimension less than about 20 microns.

A 13^{th} embodiment is any combination of the first 12 embodiments, wherein the nanoparticles have at least one dimension less than about 1 micron.

A 14^{th} embodiment is any combination of the first 13 embodiments, wherein the nanoparticles comprise mini fibers having at least one dimension between about 1 micron and about 20 microns.

A 15^{th} embodiment is any combination of the first 14 embodiments, wherein the mini fibers have at least one dimension of about 5 microns.

A 16^{th} embodiment is any combination of the first 15 embodiments, wherein the mini fibers are selected from a group consisting of metallic fibers, carbon fibers, polypropylene (PP), nylon fibers, polybutylene (PBT), ethylene polyester (PET), polylactic acid (PLA), polyamide (PA), glass, biosoluble glass, ceramic materials, acrylic, polyethylene, high density polyethylene (HDPE) low density polyethylene (LDPE) and combinations thereof.

A 17^{th} embodiment is any combination of the first 16 embodiments, wherein the fiber substrate comprises polyolefins, polyester, polyethylene (PE), polypropylene (PP), blends of PP and PE, PBT, PET, CoPET, PLA, PA, PHB, PVOH, polyamide and combinations thereof.

In another aspect, an intake filter is provided comprising any combination of the first 17 embodiments.

In another aspect, a panel filter is provided comprising any combination of the first 17 embodiments.

In another aspect, a filter press is provided comprising any combination of the first 17 embodiments.

In another aspect, a rotary drum filter is provided comprising any combination of the first 17 embodiments.

In another aspect, a fuel filter is provided comprising any combination of the first 17 embodiments.

In another aspect, a semiconductor processing filter is provided comprising any combination of the first 17 embodiments.

In another aspect, a pipeline filter is provided comprising any combination of the first 17 embodiments.

In another aspect, a wastewater filter is provided comprising any combination of the first 17 embodiments.

In another aspect, a microfiltration membrane.is provided comprising any combination of the first 17 embodiments.

In another aspect, a water filter.is provided comprising any combination of the first 17 embodiments.

In another aspect, a hydraulic filter is provided comprising any combination of the first 17 embodiments.

In another aspect, a metallic filter.is provided comprising any combination of the first 17 embodiments.

What is claimed is:

1. A filter media for a liquid filter, the filter media comprising:
a substrate comprising one or more fibers and having a first surface and an opposing second surface; and
a plurality of nanoparticles disposed within the substrate at least between the first and second surfaces, wherein at least some of the nanoparticles are bonded to at least some of the fibers within the substrate.

2. The filter media of claim 1, wherein at least some of the nanoparticles are thermally bonded to at least some of the fibers.

3. The filter media of claim 1, further comprising a binding agent within the substrate retaining at least some of the nanoparticles to at least some of the fibers.

4. The filter media of claim 3, wherein the binding agent comprises a non-soluble adhesive.

5. The filter media of claim 1, wherein the nanoparticles have at least one dimension less than about 20 microns.

6. The filter media of claim 1, wherein the nanoparticles have at least one dimension less than about 1 micron.

7. The filter media of claim 1, wherein the nanoparticles comprise mini fibers having at least one dimension between about 1 micron and about 20 microns.

8. The filter media of claim 7, wherein the mini fibers have a length of about 100 microns to about 600 microns.

9. The filter media of claim 7, wherein the mini fibers are selected from a group consisting of metallic fibers, carbon fibers, polypropylene (PP), nylon fibers, polybutylene (PBT), ethylene polyester (PET), polylactic acid (PLA), polyamide (PA), glass, biosoluble glass, ceramic materials, acrylic, polyethylene, high density polyethylene (HDPE) low density polyethylene (LDPE) and combinations thereof.

10. The filter media of claim 1, wherein the substrate comprises a porous membrane.

11. The filter media of claim 1, wherein the fibers are biocomponent fibers comprising CoPET/PET or HDPE/PET.

12. The filter media of claim 1, wherein the substrate has a thickness from a first surface to a second surface, wherein the nanoparticles are disposed within the substrate in at least 50% of the thickness from the first surface to the second surface.

13. The filter media of claim 1, wherein the nanoparticles are disposed within the fiber substrate from the first surface to the second surface.

14. The filter media of claim 1, wherein the nanoparticles are generated within a gas and dispersed through a first surface of the fiber substrate.

15. A liquid filter comprising:
a housing comprising an inlet for receiving a liquid and an outlet for discharging the liquid; and
a filter media disposed within the housing between the inlet and the outlet, the filter media comprising:
a substrate comprising one or more fibers and having a first surface and an opposing second surface; and
a plurality of nanoparticles disposed within the substrate at least between the first and second surfaces, wherein the filter media has a mean flow pore size of less than about 10 microns.

16. The filter of claim 15, wherein the mean flow pore size is less than about 4 microns.

17. The filter of claim 15, wherein a ratio of a maximum flow pore size to the mean flow pore size is less than about 10.

18. The filter of claim 17, wherein the ratio is less than about 6.

19. The filter of claim 15, wherein the filter media has a bubble point of less than about 20 in/h20.

20. The filter of claim 19, wherein the bubble point is less than about 15 in/h20.

21. The filter of claim 15, wherein the filter media further comprises a support layer.

22. The filter of claim 15, wherein at least some of the nanoparticles are thermally bonded to at least some of the fibers.
